(19) United States
(12) Patent Application Publication
(10) Pub. No.: US 2019/0160856 A1
(43) Pub. Date: May 30, 2019

(54) METHODS AND SYSTEMS TO CREATE A MAILPIECE WITH AN INLINE BUCKLE FOLDER

(71) Applicant: Bell and Howell, LLC, Durham, NC (US)

(72) Inventors: Neal J. Middelberg, Apex, NC (US); Craig S. Adcock, Raleigh, NC (US); Michelle Demers, New Hill, NC (US); Vince Tucci, Raleigh, NC (US); Dale R. Curry, Chapel Hill, NC (US); Todd Murdock, Clayton, NC (US)

(21) Appl. No.: 15/827,659

(22) Filed: Nov. 30, 2017

(51) Int. Cl. B43M 3/04; B31B 70/26

(52) U.S. Cl. CPC B43M 3/045; B31B 70/262

(57) ABSTRACT

Systems and methods of forming a mailpiece by folding an envelope sheet around one or more insert sheets (e.g., an insert stack) include creating the insert stack, staging the insert stack proximate to the transport path of the envelope sheet, dispensing the insert stack onto the envelope sheet, applying adhesive to the envelope sheet, using a buckle folder to wrap the envelope sheet at least partially around the insert stack to form an unsealed envelope without stopping the envelope sheet and without bending the insert stack, folding the envelope flap of the unsealed envelope onto the back thereof using a plow folder, and sealing the flap of the envelope to the back of the envelope, creating the mailpiece.

### TECHNICAL FIELD

The subject matter described herein relates generally to creating mailpieces in an automated manner. More particularly, the subject matter described herein relates to creating mailpieces in an automated manner using a buckle folder without folding printed material to be inserted within each mailpiece.

### BACKGROUND

It has become commonplace for mailpieces to be mass generated and sent to designated recipients through the U.S. Postal Service. These mailpieces can contain a variety of printed insert materials (e.g., “inserts” or, taken together, an “insert stack”), which can include, for example, invoices, account statements, and/or marketing materials (e.g., pre-printed advertisement materials). According to the known solutions for creating these mailpieces, large and cumbersome systems are implemented to carry out a method of “stuffing” the printed insert materials within pre-assembled envelopes to create these mailpieces. In such known solutions, these pre-assembled envelopes generally are stopped at one or more specified positions so that they can be opened (e.g., by applying a vacuum or by other mechanical devices) for insertion of the printed insert materials therein. However, this approach requires that the envelopes be pre-assembled and delivered to the inserting machine in regular intervals to be manually loaded into the inserting machine by an operator. Because the envelopes must come to a stop within the inserting machine during processing, such conventional inserters suffer from relatively frequent paper jams and significant mailpiece damage.

Furthermore, currently known solutions suffer from insufficient adhesive “hygiene” (e.g., unwanted glue transfer, accumulation, and/or build up, whereby glue is dispensed on an envelope sheet to form a mailpiece, yet the envelope sheet is misfed, causing glue to adhere to the machinery downstream, when it should be only on and within the envelope sheet.

Some have attempted to increase throughput of mailpieces by modifying such inserting machines to decrease the relative velocity between the printed insert materials and the envelope. This can be done by either slowing the envelope through the inserting machine or accelerating the printed insert materials along the assembly path, so that the envelope or the printed insert materials can overtake the other, resulting in an assembled envelope. However, even these attempts have been unable to overcome all of the known drawbacks associated with such inserting machines, such as using pre-assembled envelopes, which must be stored after their assembly, are subject to deterioration from potentially non-optimal environmental conditions, and require significant manual labor for their loading in the inserting machines. Furthermore, while these inserting machines may be capable of reaching higher processing speeds, the required motion controllers needed to control the precise location of the envelope for the insertion of the printed insert materials leads to an increased cost and size of such inserting machines, while the act of inserting the printed insert materials into a moving pre-assembled envelope requires a certain amount of travel (e.g., “runway”) over which the inserting occurs, thus requiring a longer and larger footprint for the inserting machine.

As such, devices, systems, and methods of creating a mailpiece containing printed insert materials without the need to use pre-assembled envelopes are disclosed herein.

### SUMMARY

The subject matter described herein relates to creating mailpieces in an automated fashion from cut paper or a continuous web of paper to form the envelopes of each mailpiece around printed insert material that is positioned on the envelope during creation of the mailpiece.

In one example embodiment, a system is provided that is configured to fold an envelope sheet around one or more insert sheets to create a mailpiece. According to this embodiment, the system comprises: an insert transport path configured to transport the one or more insert sheets to a merge region; a primary transport path configured to transport the envelope sheet to the merge region; an insert stager that is connected to the insert transport path and arranged proximate to the primary transport path at the merge region, the insert stager being configured to receive the one or more insert sheets from the insert transport path in a form of an insert stack, hold the insert stack until the envelope sheet is detected at a first position on the primary transport path, and to dispense the insert stack onto the envelope sheet as the envelope sheet is being transported along the primary transport path, the insert stack being dispensed from the insert stager at substantially a same speed as a speed at which the envelope sheet moves along the primary transport path; an adhesive dispensing system configured to seal sides of the envelope by applying glue along lateral edges of a back side portion of the envelope sheet as the envelope sheet is fed into a buckle folder; a buckle folder system configured to form an unsealed envelope for the mailpiece by folding the envelope sheet around the insert stack, wherein folding the envelope sheet around the insert stack forms, on a first side of the insert stack, a back side of the mailpiece and, on a second side of the insert stack opposite the first side, a flap and a front of the mailpiece; and an envelope closing system configured to close and seal the unsealed envelope by folding the flap over the back side and adhesively sealing the flap to the back side of the mailpiece.

In another such example embodiment, a method of folding an envelope sheet around one or more insert sheets to create a mailpiece is provided. According to this embodiment, the method comprises: forming an insert stack from the one or more insert sheets; transporting the insert stack to a merge region along an insert transport path; transporting the envelope sheet to the merge region along a primary transport path; receiving the insert stack at an insert stager that is connected to the insert transport path and arranged proximate to the primary transport; holding the insert stack within the insert stager; detecting the envelope sheet at a first position on the primary path; dispensing the insert stack onto the envelope sheet as the envelope sheet is transported along the primary transport path, wherein the insert stack is dispensed at substantially a same speed as a speed at which the envelope sheet moves along the primary transport path; folding the envelope sheet around the insert stack to form an unsealed envelope for the mailpiece, wherein the unsealed envelope comprises, on a first side of the insert stack, a back side of the mailpiece and, on a second side of the insert stack opposite the first side, a flap and a front of the mailpiece; and closing and sealing the unsealed envelope by folding the flap over the back side and adhesively sealing the flap to the back side of the mailpiece.

In yet another example embodiment, a device configured to sequentially receive and dispense one or more insert sheets as an insert stack onto an adjacent envelope sheet is provided. According to this embodiment, the device comprises: a holding slot for the insert stack; a stop gate disposed at an exit of the holding slot; and a mechanical linkage system configured to produce first and second motion profiles from a single input, the mechanical linkage system comprising: a motor configured to generate a locomotive force, wherein the locomotive force is the single input; a crank arm that is connected to the motor; a coupler linkage coupled, at a first end, to the crank arm via a coupler bearing and, at a second end, to a pivot bearing; a first linkage subassembly rotatably connected, at a first end, to the coupler linkage at the pivot bearing and comprising a stop gate arranged at a distal end of the first linkage subassembly, the single input being transmitted to the first linkage subassembly through the pivot bearing to generate the first motion profile, wherein the first motion profile is a rotary movement of the stop gate along a stop gate travel path; one or more insert drive rollers arranged so that one or more portions thereof protrude, at least partially, through a bottom side of the holding slot; one or more insert idler rollers arranged substantially vertically over the one or more insert drive rollers; a second linkage subassembly rotatably connected, at a first end, to the coupler linkage at the pivot bearing and comprising the one or more insert idler rollers, the single input being transmitted to the second linkage subassembly through the pivot bearing to generate the second motion profile, wherein the second motion profile is a substantially vertical movement of the one or more insert idler rollers about an idler pivot; wherein the mechanical linkage system is configured such that the single input simultaneously causes the first and second motion profiles of the stop gate and the one or more insert idler rollers, respectively, and wherein the first and second motion profiles are different from each other.

In still another example embodiment, a system configured to create a mailpiece with an external envelope folded around one or more insert materials is provided. According to this embodiment, the system comprises: one or more insert feeders configured to dispense one or more insert sheets onto an insert transport plate, wherein the one or more insert sheets from each insert feeder are stacked sequentially on top of each other to form an insert stack; an insert assembly transport belt configured to transport the insert stack on top of the insert transport plate; an envelope sheet feeder configured to dispense an envelope sheet onto an envelope transport plate; an envelope conveyor configured to transport the envelope sheet along the envelope transport plate by an envelope conveyor belt, wherein a speed of the insert assembly transport belt is different from a speed of the envelope conveyor belt; an insert stager located adjacent to the envelope conveyor at a merge region, wherein the insert stager is configured to: receive the insert stack from the insert assembly transport belt; hold the insert stack until triggered by a merge optical sensor to dispense the insert stack; and dispense, at a same time as or after the merge optical sensor detects the envelope sheet at a dispensing position, the insert stack onto an insert area of the envelope sheet, wherein the envelope sheet is in continuous motion while the insert stack is dispensed thereon; one or more adhesive applicators that are configured to apply an adhesive proximate to lateral edges of the envelope sheet in at least a portion of the insert area thereof; a buckle folder comprising: a fold plate arranged out of a plane defined by a direction of travel of the envelope sheet; a fold diverter configured to divert a leading edge of the envelope sheet onto the fold plate when triggered from a rest position into an actuated position at a same time as or after a diverter optical sensor detects the leading edge of the envelope sheet; a fold plate stop bar configured to prevent the leading edge of the envelope sheet from moving beyond a position on the fold plate, the position corresponding to a size of the envelope sheet, the insert stack, and/or the mailpiece; wherein the fold diverter is configured to move back to the rest position before or at a same time as the leading edge of the envelope sheet contacts the fold plate stop bar; a first plurality of transport rollers that are configured to drive the envelope sheet past the one or more adhesive applicators, onto the fold plate until the leading edge of the envelope sheet contacts the fold plate stop bar, and, after the leading edge of the envelope sheet contacts the fold plate stop bar, underneath the fold plate; a second plurality of transport rollers located behind the fold plate which are configured to fold the envelope sheet at an envelope primary fold point; one or more adhesive sealing rollers that are substantially aligned with the edges of the envelope sheet along which the adhesive is dispensed by the one or more adhesive applicators, wherein the one or more adhesive sealing rollers are configured to apply a compressive force to seal a back region of the envelope sheet onto the insert region of the envelope sheet, thereby forming an unsealed envelope; one or more right angle turn (RAT) modules configured to turn the unsealed envelope by substantially 90 degrees; a pair of crease rollers configured to form an envelope flap crease line at a bottom edge of a flap region of the unsealed envelope; an adhesive applicator configured to dispense an adhesive onto the flap region; a plow fold guide and plow folder configured to fold the flap region over to cover, at least partially, the back region of the unsealed envelope; a flap sealer configured to compressively seal the flap region onto the back region, thereby sealing the unsealed envelope to form the mailpiece; and an output receptacle configured to receive the mailpiece.

The subject matter described in this specification may be implemented in hardware, software, firmware, or combinations of hardware, software and/or firmware. In some examples, the subject matter described in this specification may be implemented using a non-transitory computer readable medium storing computer executable instructions that when executed by one or more processors of a computer cause the computer to perform operations. Computer readable media suitable for implementing the subject matter described in this specification include non-transitory computer-readable media, such as disk memory devices, chip memory devices, programmable logic devices, random access memory (RAM), read only memory (ROM), optical read/write memory, cache memory, magnetic read/write memory, flash memory, and application specific integrated circuits. In addition, a computer readable medium that implements the subject matter described in this specification may be located on a single device or computing platform or may be distributed across multiple devices or computing platforms.

Embodiments of the presently disclosed subject matter having been stated hereinabove, and which is achieved in whole or in part by the presently disclosed subject matter, other embodiments will become evident as the description proceeds when taken in connection with the accompanying Examples as best described hereinbelow.

### BRIEF DESCRIPTION OF THE DRAWINGS

The presently disclosed subject matter can be better understood by referring to the following figures. The components in the figures are not necessarily to scale, emphasis instead being placed upon illustrating the principles of the presently disclosed subject matter (often schematically). In the figures, like reference numerals designate corresponding parts throughout the different views. A further understanding of the presently disclosed subject matter can be obtained by reference to an embodiment set forth in the illustrations of the accompanying drawings. Although the illustrated embodiment is merely exemplary of systems for carrying out the presently disclosed subject matter, both the organization and method of operation of the presently disclosed subject matter, in general, together with further objectives and advantages thereof, may be more easily understood by reference to the drawings and the following description. The drawings are not intended to limit the scope of this presently disclosed subject matter, which is set forth with particularity in the claims as appended or as subsequently amended, but merely to clarify and exemplify the presently disclosed subject matter. Portions for subassemblies have been omitted from the drawings in order to make otherwise occluded components visible.

For a more complete understanding of the presently disclosed subject matter, reference is now made to the following figures (“FIGS.”), in which:

FIG. 1 is a schematic illustration of the components of an example embodiment of a system configured to create a mailpiece with an external envelope folded around one or more inserts dispensed on the unfolded envelope during formation of the mailpiece;

FIG. 2 is a perspective view of an example embodiment of the envelope sheet feeder of the system of FIG. 1;

FIG. 3 is a perspective view of a portion of an example embodiment of the system of FIG. 1, including an example embodiment of the envelope and insert merge region;

FIGS. 4A through 4D are various perspective views of the insert stager illustrated in FIG. 3;

FIGS. 4E through 4G are side views of the mechanical linkage system that controls the output of the insert stager;

FIG. 5 is a side view of an example embodiment of the envelope and insert merge region of the system of FIG. 1, including the insert stager of FIG. 4 and an example embodiment of a buckle folder;

FIG. 6 is a perspective view of an envelope sheet and one or more inserts entering the adhesive applicator unit and the buckle folder of FIG. 1, with the insert stager omitted for clarity;

FIG. 7 is a perspective view of the envelope sheet being diverted into the buckle folder of the system of FIG. 1;

FIG. 8 is a perspective view of the envelope sheet as the envelope sheet is formed into an envelope by the buckle folder and is drawn underneath the fold plate by a set of transport rollers;

FIG. 9 is a second perspective view of the envelope sheet in approximately the same position as is shown in FIG. 8, but including details about application of the adhesive to the envelope sheet during envelope formation;

FIG. 10 is a side view of the envelope sheet passing underneath the fold plate of the buckle folder and into the adhesive rollers to seal the front and back of the envelope together;

FIG. 11 is a perspective view of an example embodiment of a portion of the system of FIG. 1, including the buckle folder, the right angle turn (RAT) unit, and the bottom edge justifier; and

FIG. 12 is a perspective view of an example embodiment of a portion of the system of FIG. 1, including the bottom edge justifier, the flap creaser, the flap adhesive applicator, the flap plow folder, and the flap sealer.

### DETAILED DESCRIPTION

The presently disclosed subject matter now will be described more fully hereinafter, in which some, but not all embodiments of the presently disclosed subject matter are described. Indeed, the presently disclosed subject matter can be embodied in many different forms and should not be construed as limited to the embodiments set forth herein; rather, these embodiments are provided so that this disclosure will satisfy applicable legal requirements.

The terminology used herein is for the purpose of describing particular embodiments only, and is not intended to be interpreted as in any way limiting the presently disclosed subject matter.

All technical and scientific terms used herein, unless otherwise defined below, are intended to have the same meaning as commonly understood by one of ordinary skill in the art. References to techniques, structures, devices, and steps employed herein are intended to refer to such techniques, structures, devices, and steps as they are commonly understood in the art, including variations on those techniques, structures, devices, and steps or substitutions of equivalent techniques, structures, devices, and steps that would be apparent to one of skill in the art. While the following terms are believed to be well understood by one of ordinary skill in the art, the following definitions are set forth to facilitate explanation of the presently disclosed subject matter.

In describing the presently disclosed subject matter, it will be understood that a number of techniques, structures, devices, and steps are disclosed. Each of these has individual benefits associated therewith, and each can also be used in conjunction with one or more, including all, of the other disclosed techniques, structures, devices, and steps.

Accordingly, for the sake of clarity, this description will refrain from repeating every possible combination and permutation of the individual steps in an unnecessary fashion. Nevertheless, the specification and claims should be read with the understanding that such combinations are entirely within the scope of and are expressly considered to constitute aspects of the invention and the claims.

Following long-standing patent law convention, the terms “a”, “an”, and “the” refer to “one or more” when used in this application, including the claims. Thus, for example, reference to “a tool” includes not only a single tool, but also a plurality of such tools, and so forth.

Unless otherwise indicated, all numbers expressing quantities of structures, elements, devices, steps, reaction conditions, and so forth used in the specification and claims are to be understood as being modified in all instances by the term “about.” Accordingly, unless indicated to the contrary, the numerical parameters set forth in this specification and attached claims are approximations that can vary depending upon the desired characteristics, behaviors, etc., sought to be obtained by the presently disclosed subject matter.

As used herein, the terms “about,” “substantially,” “approximately,” and any other such synonymous terminology, when referring to a value, a degree, or an amount of a composition, mass, weight, temperature, time, volume, concentration, percentage, etc., is meant to encompass variations of, for example, ±20% in some embodiments, ±10% in some embodiments, ±5% in some embodiments, ±3% in some embodiments, ±2% in some embodiments, ±1% in some embodiments, ±0.5% in some embodiments, and ±0.1% in some embodiments from the specified amount, degree, or amount, as such variations would be known by those having ordinary skill in the art as being appropriate to construct and/or operate the disclosed devices and/or systems, perform the disclosed methods, and/or employ the disclosed compositions.

The term “comprising”, which is synonymous with “including,” “containing,” or “characterized by,” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials, devices, structures, behaviors, or steps, plus those that do not materially affect the basic and novel characteristic(s), behavior(s), etc., of the claimed subject matter.

With respect to the terms “comprising”, “consisting of”, and “consisting essentially of”, where one of these three terms is used herein, the presently disclosed and claimed subject matter can include the use of either of the other two terms.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

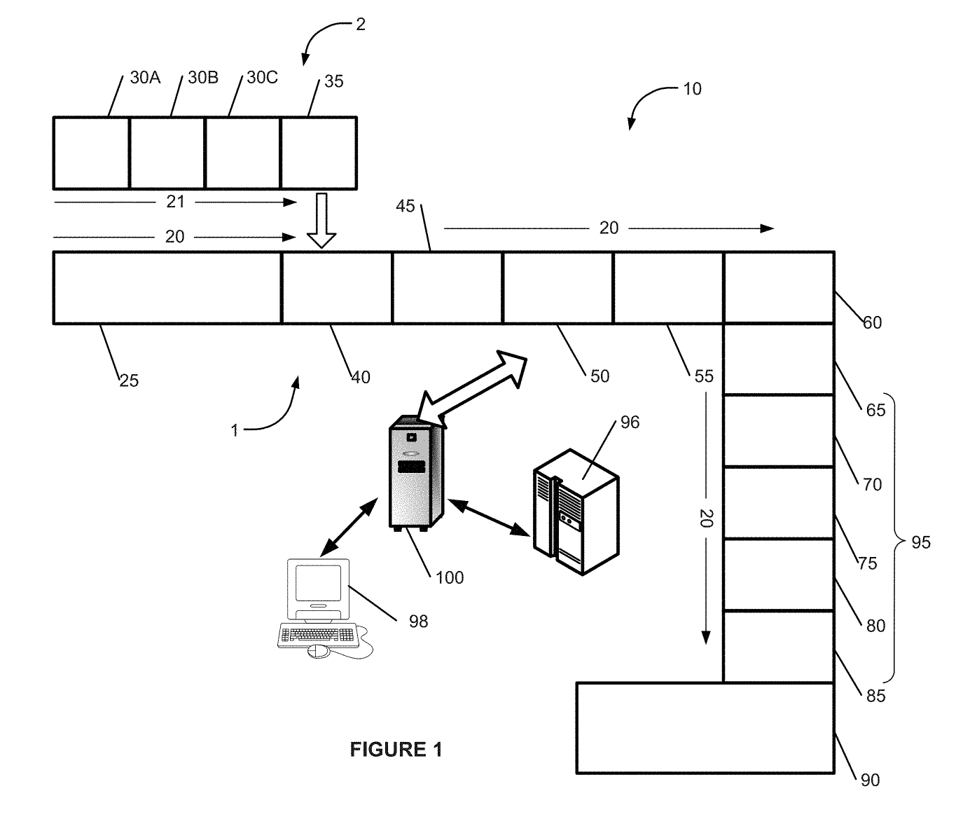

FIG. 1 is a schematic diagram of a mailpiece enveloping system, generally designated 10, which is configured to generate at least one (e.g., a plurality) sealed envelope from a sheet of paper (or any suitable fibrous material), using a buckle folder so that each envelope contains one or more insert (e.g., “printed insert material) therein. In forming the envelope, the envelope sheet moves through system 10 at a substantially constant speed, including when the one or more insert is positioned on a designated area of the envelope sheet.

As can be seen in FIG. 1, three insert feeders 30A, 30B, and 30C are positioned in an insert transport path, generally designated 2, which is parallel to and/or vertically above (e.g., higher than) a primary transport path, generally designated 1, along which the envelope sheet and the inserts, after their merger with the envelope sheet, are transported. Primary transport path 1 is oriented along the direction of travel 20, while insert transport path 2 is oriented to be substantially along the insert direction of travel 21. In some embodiments, directions of travel 20 and 21 can be parallel to each other, substantially parallel to each other, or at an angle relative to each other (e.g., 30°, 45°, 60°, 75°, 90°, or 90°±10°). It is contemplated that only a single insert feeder (e.g., 30C) is installed, that two insert feeders (e.g., two of 30A, 30B, and 30C are installed, or that more than three insert feeders (e.g., 30A, 30B, 30C, . . . , 30N) can be installed in or along insert transport path 2. In embodiments where a plurality of insert feeders are installed in or along insert transport path 2, one, some, or even all of such a plurality of insert feeders can be selectively disabled (e.g., electronically by computer 100 or manually by a human operator) so that less than all of the insert feeders will deposit (e.g., eject) an insert stored therein on top of inserts deposited on insert transport path 2 by “upstream” insert feeders (e.g., 30A is “upstream” of both 30B and 30C, while 30B is “upstream” of 30C but “downstream” of 30A).

In such embodiments where multiple inserts are being deposited onto insert transport path 2 by two or more (or all) of insert feeders 30A, 30B, and 30C, an insert stack is created, with the first insert in the stack being deposited by the furthest “upstream” insert feeder that is active (e.g., 30A) for the mailpiece being assembled, and the subsequent inserts to be included in the insert stack being deposited in a sequential manner on top of an insert deposited by an immediately “upstream” active insert feeder. For example, where the insert stack includes two inserts, the first, or primary, insert (e.g., the bottom insert of the insert stack) is deposited by insert feeder 30A onto insert transport path 2, then the second, or secondary, insert (e.g., the top insert of the insert stack) is deposited by insert feeder 30B or 30C, whichever is active, on top of the first insert as the first insert is carried by active insert feeder 30B or 30C along insert transport path 2. In another embodiment, where the insert stack has three inserts, insert feeder 30A deposits the first insert onto insert transport path 2. The first insert then moves along insert transport path 2 to pass underneath, or otherwise adjacent to (e.g., beside), insert feeder 30B, which deposits a second insert on top of first insert, so as to at least partially cover the first insert. The first and second inserts then move along insert transport path 2 to pass underneath or otherwise adjacent to (e.g., beside), insert feeder 30C which deposits a third insert on top of first and second inserts, so as to at least partially cover the first insert, the second insert, or portions of both the first and second insert.

In embodiments where a plurality of inserts (e.g., an insert stack) is to be included in an assembled mailpiece, it is possible for the inserts to be arranged in the insert stack in any order, without regard for the dimensions of the respective inserts in the insert stack. However, in some such embodiments, the first insert at the bottom of the insert stack is the largest (e.g., in width, height, or thickness) insert, with each insert subsequently deposited in the insert stack having the same or smaller dimensions than the immediately adjacent insert. By this arrangement and in embodiments where each insert has a different shape and/or one or more dimension from the other inserts in the insert stack, the inserts can be arranged to provide a visually appealing “cascading” arrangement (e.g., where each insert is partially visible behind the insert which is arranged directly in front thereof) when the insert stack is front, rear, or side registered.

Regardless of the arrangement or the number of inserts included in the insert stack, the inserts are deposited one on top of each other along insert transport path 2, and are held, at least temporarily, in an insert stager 35 until triggered to be deposited (e.g., ejected) out of insert stager 35 and onto a designated portion of a substantially flat envelope sheet being transported underneath, beside, or otherwise adjacent to insert stager 35 as the envelope sheet moves, along primary transport path 1, from envelope sheet feeder 25 into merge region 40, where the insert stack merges with the envelope sheet. The merged envelope sheet and insert stack move together in the direction of travel 20, with substantially no relative movement therebetween, into adhesive applicator region 45, where adhesive is applied along at least a portion of the sides of the envelope sheet. Next, the merged envelope sheet and insert stack enter a buckle folder system 50, where the envelope is formed without any creasing or substantial bending of the insert stack. The merged envelope sheet and insert stack then enter the side adhesive sealer 55, where the adhesive applied to the envelope sheet in adhesive applicator region 45 is activated (e.g., by pressure) to sealingly form the envelope. After the envelope is adhesively sealed on the lateral sides thereof, a right angle turn (RAT) module 60 changes the direction of travel 20 of the partially formed envelope, without actually rotating the envelope, so that the envelope is then bottom edge registered by a bottom edge justifier 65. The use of RAT module 60 allows for system 10 to occupy a more compact footprint where an operator can access the majority of the components therein from a single position, rather than having to traverse the length of system 10, thus allowing for faster error intervention and correction, reducing downtime of system 10. In some embodiments, the envelope itself can be turned rather than having its direction of travel 20 changed. Once the envelope is bottom edge registered, a crease for folding the flap and sealing the envelope is formed passing the envelope through a flap creaser 70 at a position designated for the crease line. After the crease is formed, adhesive is applied, using a flap adhesive applicator 75, to the flap and/or an adjacent part of the rear portion of the envelope, against which the flap will be sealed. With the adhesive applied to seal the flap to the rear portion of the envelope, the envelope passes through flap plow folder 80, which bends the flap over, and then through a flap sealer 85 which activates the adhesive (e.g., by pressure) to seal the flap portion against the rear portion of the envelope. One or more of flap creaser 70, flap adhesive applicator 75, flap plow folder 80, and/or flap sealer 85 can be collectively referred to as “envelope closing system” 95. Finally, the sealed envelope is deposited into an output section 90, such as a basket, tray, cart, conveyor, or any suitable mailpiece receptacle and/or transport device.

System 10 is configured to be controlled by a computer 100, using information obtained from a server 96. Computer is configured for control, either remote or local, by an operator by a user terminal 98. In some embodiments, server 96 has a list of “jobs” in a queue, with the “jobs” being orders for mailpieces that need to be created. In some such embodiments, one or more of the “jobs” may direct an operator to change one or more setting or component of system 10 for the particular mailpiece assembly job to be performed. For example, where a unique invoice is to be included in each mailpiece, the operator may be instructed to place such invoices into one of the insert feeders 30A, 30B, and 30C for insertion into each of the mailpieces. The operational throughput (e.g., volume of mailpieces), errors, warnings, envelope sheet size, insert stack size, and any other operational parameters can be input by and/or displayed to an operator through user terminal 98 and transmitted to and/or from computer 100, so that when an error condition (e.g., a paper jam) is detected or an informational message (e.g., low paper) needs to be displayed, computer 100 can display such messages to the operator at user terminal 98, thus directing the operator to the specific location of the error or the location to which the informational message pertains for corrective action. System 10 operation and control may be configured, in some embodiments, to use PLC (Programmable Logic Controller) components and a control panel (e.g., a user input device) for system operation. In some other embodiments, system 10 may be controlled by computer 100. In still other embodiments, system 10 may be controlled by some combination of the components described above (e.g., PLC components, a control panel, and/or computer 100). System 10 is configured to process and generate up to and including 15,000 mailpieces per hour. In some embodiments, system 10 can process and generate from as few as 1,000 and up to 20,000 mailpieces per hour. Regardless of the particular design aspects (e.g., throughput, size of envelope, etc.) of each design of such systems, these systems, are nevertheless simpler to build, maintain, and operate, as there are fewer moving parts to those known in the art, no suction is needed to open an envelope for insertion of the printed material(s), there is no flap opener needed to manipulate the envelope, etc.

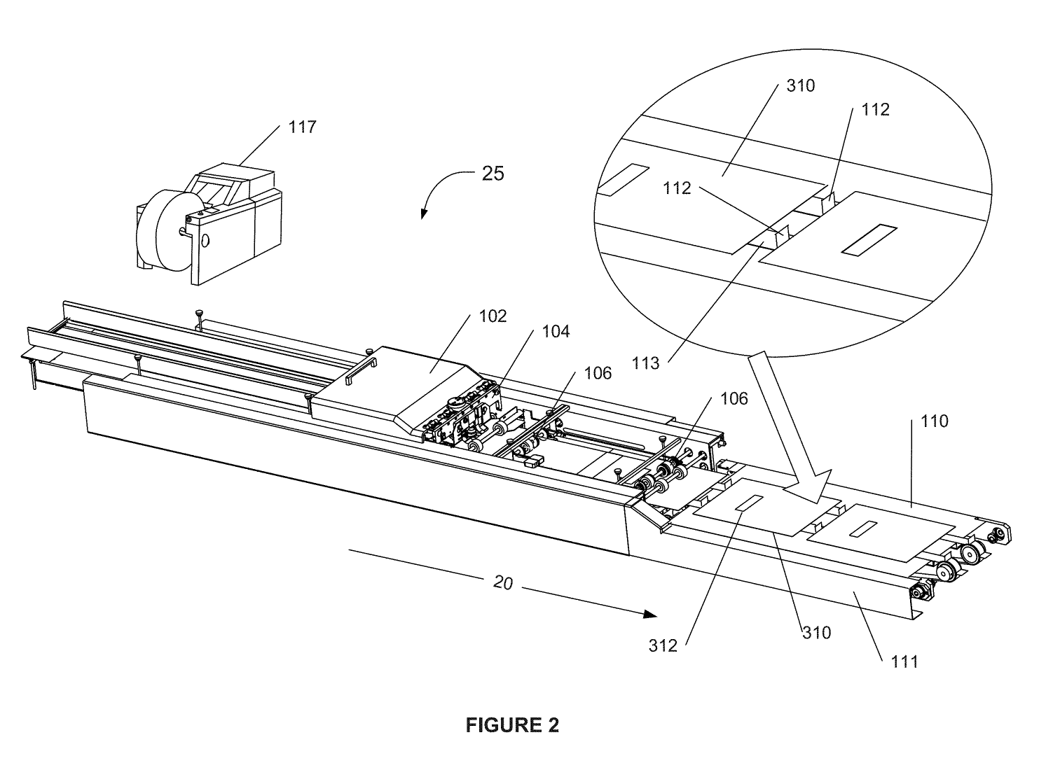

Referring now to FIG. 2, an envelope sheet feeder, generally designated 25, is illustrated according to an example embodiment of system 10 of FIG. 1. In the embodiment of FIG. 1, envelope sheets 310 are contained within an envelope sheet hopper 102. Envelope sheets 310 can be either plan paper stock or pre-printed with any suitable material (e.g., images and/or text). In some aspects, the plain paper stock can be advantageous in that there is no need to have pre-printed inventory, eliminating a common scenario where such pre-printed inventory becomes outdated (e.g., replaced with a new design) while in storage. Envelope sheets 310 are individually dispensed from envelope sheet hopper 102 by envelope sheet dispenser 104 and transported onto envelope conveyor 111, which may be disposed on, or separate from, an envelope transport plate 110, by one or more feeder rollers 106. Once on envelope conveyor 111, envelope sheets 310 are rear edge registered by one or more tabs 112 formed on or otherwise attached to one or more envelope conveyor belts 113. These tabs 112 push envelope sheets 310 along envelope conveyer 111. In the embodiment shown, envelope sheets 310 have an envelope window 312 formed therein. In some embodiments, envelope window 312 is covered by a glassine layer to protect the contents of the assembled mailpiece.

Envelope window 312 allows for unique printed information on an insert visible within an assembled mailpiece to be externally visible, such as would be necessary for address information to be visible for delivery. In some embodiments, a plurality of envelope windows 312 can be formed in envelope sheet 310, enabling, for example, a return address to be visible. In such embodiments, envelope window 312 allows for unique mailings to be created based on insert contents and not based on unique printing on the outside of an assembled envelope. In some embodiments, envelope sheet hopper 102 and envelope sheet dispenser 104 can be replaced with a paper dispenser and cutter 117, which is configured to form the envelope sheets 310 from a continuous web (e.g. roll) of paper that is cut to the proper size for a given assembled mailpiece. While envelope window 312 is shown already formed into envelope sheet 310, it is possible in some embodiments for envelope window 312 to be formed in envelope sheet 310 “on demand” (e.g., during envelope assembly) by, for example, a laser cutting device or a die-cutting device. This can be especially useful where paper dispenser and cutter 117 is used, such that envelope sheets 310 are formed from a continuous web of paper, rather than from pre-cut paper stock, as is shown in FIG. 2.

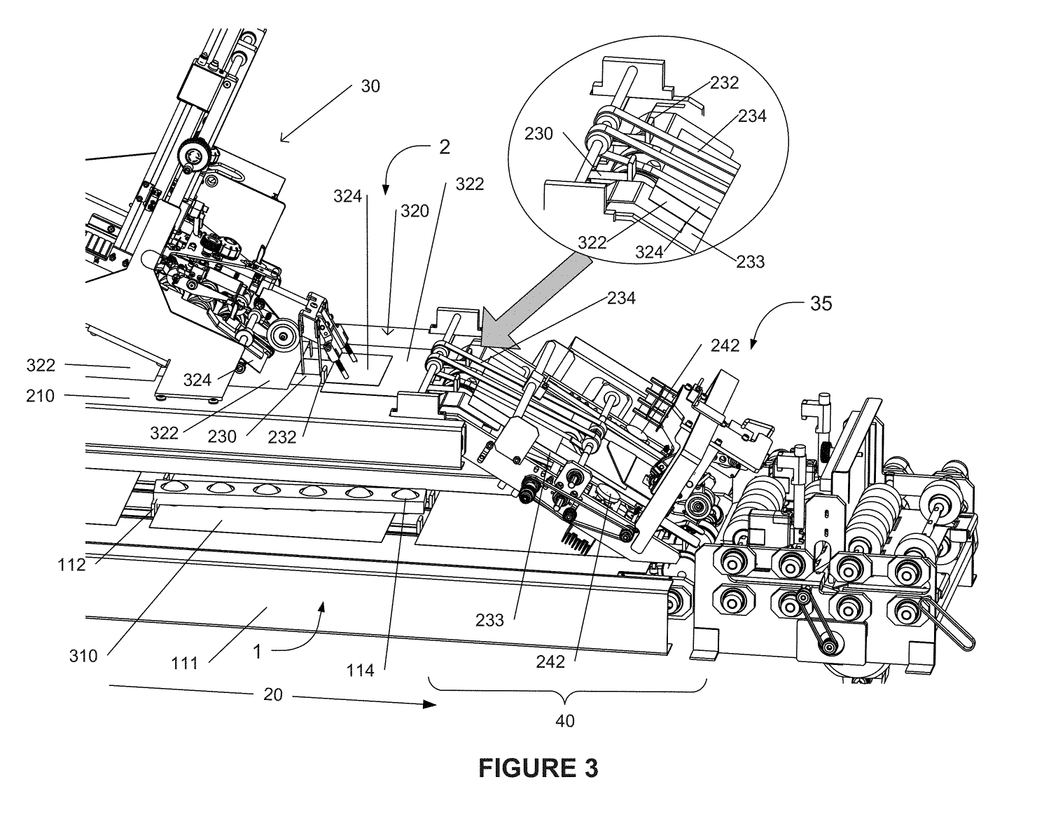

In FIG. 3, an insert feeder, generally designated 30, is shown located vertically above envelope conveyor 111. While a single insert feeder 30 is shown, it is noted that a plurality of such insert feeders arranged sequentially is expressly contemplated (see, e.g., FIG. 1) and, in fact, at least one such “upstream” insert feeder (e.g., 30A or 30B) is present and active in the example embodiment shown in FIG. 3, as primary inserts 322 are moving underneath insert feeder 30 along insert transport path 2, such that insert feeder 30 deposits secondary insert 324 on top of primary insert 322 as primary insert 322 moves adjacent to (e.g., underneath) insert feeder 30. In this embodiment, all inserts, including primary insert 322 and secondary insert 324, move at a constant speed along insert transport path 2 after being dispensed from a respective insert feeder 30 onto insert stack, generally designated 320. Insert stack 320 moves along insert transport path 2, being driven by insert assembly transport belt 230 and each of the inserts in insert stack 320 being rear edge registered by tabs 232 formed on or substantially fixedly attached to insert assembly transport belt 230.

In some embodiments, a first insert assembly (e.g., 30A, see FIG. 1) deposits a primary insert 322 (e.g., a control insert) onto insert assembly transport belt 230, which is rear edge registered by tabs 232. Next, as primary insert 322 moves into a second position (e.g., under or adjacent to a first insert assembly, such as 30B in FIG. 1), a secondary insert 324 is inserted on top of primary insert 322, thus creating insert stack 320. In some embodiments, one or more further inserts (e.g., a tertiary insert, et seq.) may be deposited onto insert stack. Each insert of insert stack 320 is rear edge registered by tabs 232. Such rear edge registering can further be provided by precisely timed depositing of the secondary (and further) inserts onto insert stack 320, as well as by normal operational vibration levels, which act to reduce relative friction between the inserts within insert stack 320. Also, the inserts may be deposited from insert feeders 30 at a speed that is less than the speed at which insert assembly transport belt 230 is moving, such that the relative difference in speeds causes the upper insert of insert stack 320 to slide backwards, relative to the insert stack, towards and into contact with tabs 232 as the upper insert of insert stack 320 is accelerated to the same speed as insert stack 320 and insert assembly transport belt 230. In some embodiments, a stationary upper belt (or portion thereof) can use friction to drag against the top surface of the upper insert of insert stack 320, thereby rear-edge registering each insert in insert stack 320 against the tabs 232.

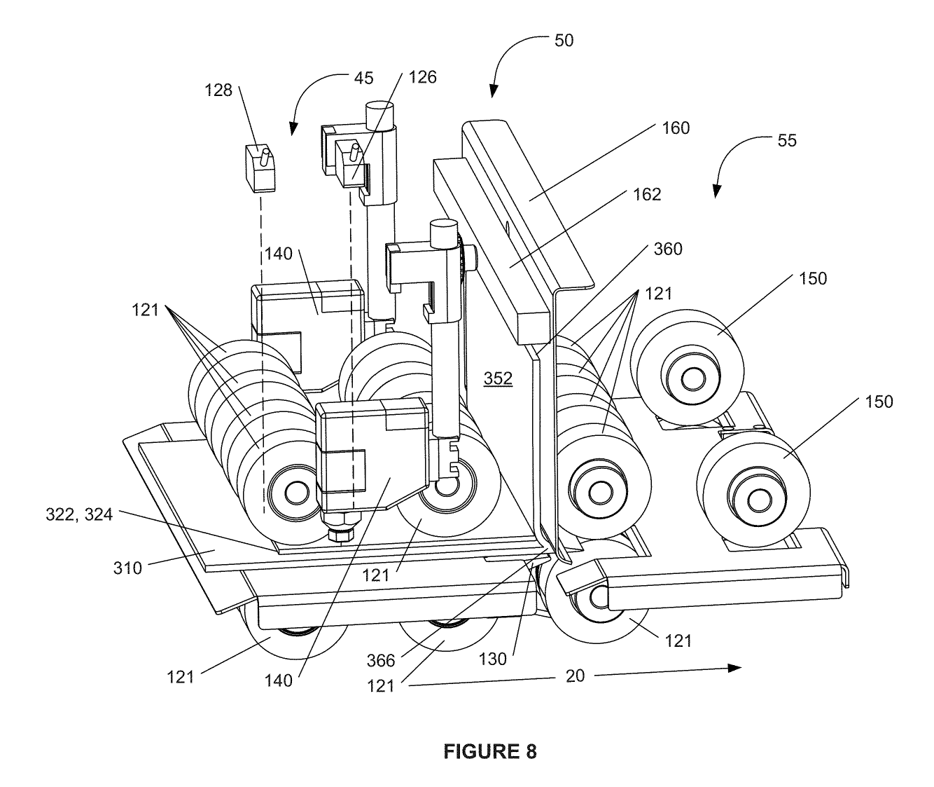

The depositing of the inserts (e.g., 322 and 324) onto insert stack 320 is precisely controlled. In some embodiments, the speed at which insert assembly transport belt 230 is moving along insert transport path 2 is known, such that a known spacing of insert assemblies (e.g., 30A, 30B, and 30C) along insert transport path 2 can be used to deposit an insert onto insert transport plate 210 at a calculated frequency and/or period. In some other embodiments, an optical sensor can be used to detect a leading edge of insert stack 320, tabs 232, and/or an optical marking on insert assembly transport belt 230, which indicates a position of insert stack 320 relative to one or more (e.g., each) insert feeder 30, such that, when the optical sensor is triggered, an electronic signal is sent for insert feeder 30 to deposit (e.g., eject) an insert (e.g., 322 or 324) onto insert transport plate 210 to become part of insert stack 320 or, in the case where primary insert 322 is being deposited, to be a first insert of an insert stack 320 being created. In some embodiments, insert stack 320 may have only a single insert, such as primary insert 322. In some other embodiments, one or more of the inserts of insert stack 320 (e.g., 322 and/or 324) can be a pre-folded sheet of paper (e.g., bi-folded or tri-folded). In the embodiment shown, each insert added onto insert stack 320 is dimensionally smaller in at least one dimension than the preceding insert of insert stack 320. In some embodiments, one or more of the inserts of insert stack 320 (e.g., 322, 324, et. seq.) can be a same size as, or even larger than, a previously deposited insert of insert stack 320. Due to the dimensional differences between insert stack 320 and envelope sheet 310, insert stack 320 moves along insert transport path 2 at substantially half the speed at which envelope sheet 310 moves along primary transport path 1. Other speed ratios between the primary and insert transport paths 1 and 2 are possible, depending on the dimensions of insert stack 320, envelope sheet 310, and/or the spacing of tabs 232 formed on or attached to insert assembly transport belt 230, which is configured to move insert stack 320 along insert transport path 2. In the example embodiment shown and described herein, the nominal speed difference of envelope sheet 310 and insert stack 320 along the primary transport path 1 and the insert transport path 2, respectively, is a two-to-one ratio, wherein the transport speed of envelope sheet 310 is double the transport speed of insert stack 320. This speed ratio improves the reliability of the placement of insert stack 320 onto envelope sheet 310 relative to envelope fold point 366 (see, e.g., FIG. 8). The speed ratio improves the probability of placement of insert stack 320 on, or slightly trailing, envelope fold point 366. In such a manner, error tolerances will not accumulate to where insert stack 320 is placed in a leading position, relative to envelope fold point 366, which would result in insert stack 320 entering buckle folder system 50, causing a malfunction (e.g., a paper jam) that would require manual intervention by one or more operators.

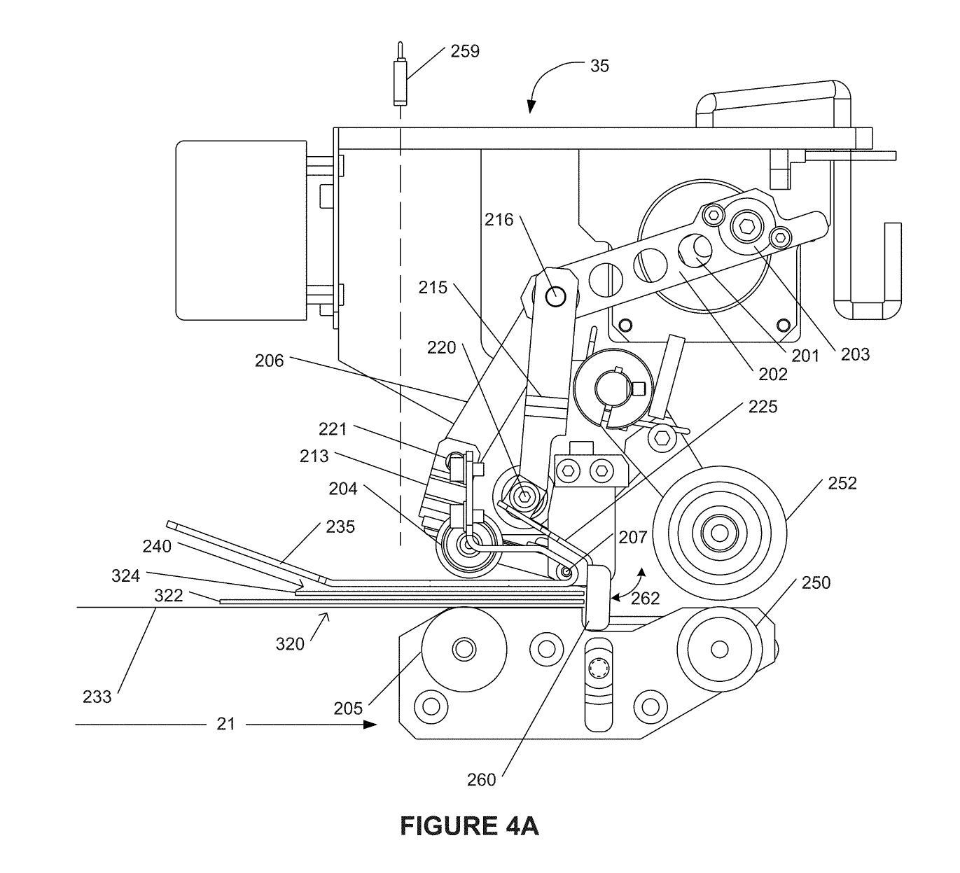

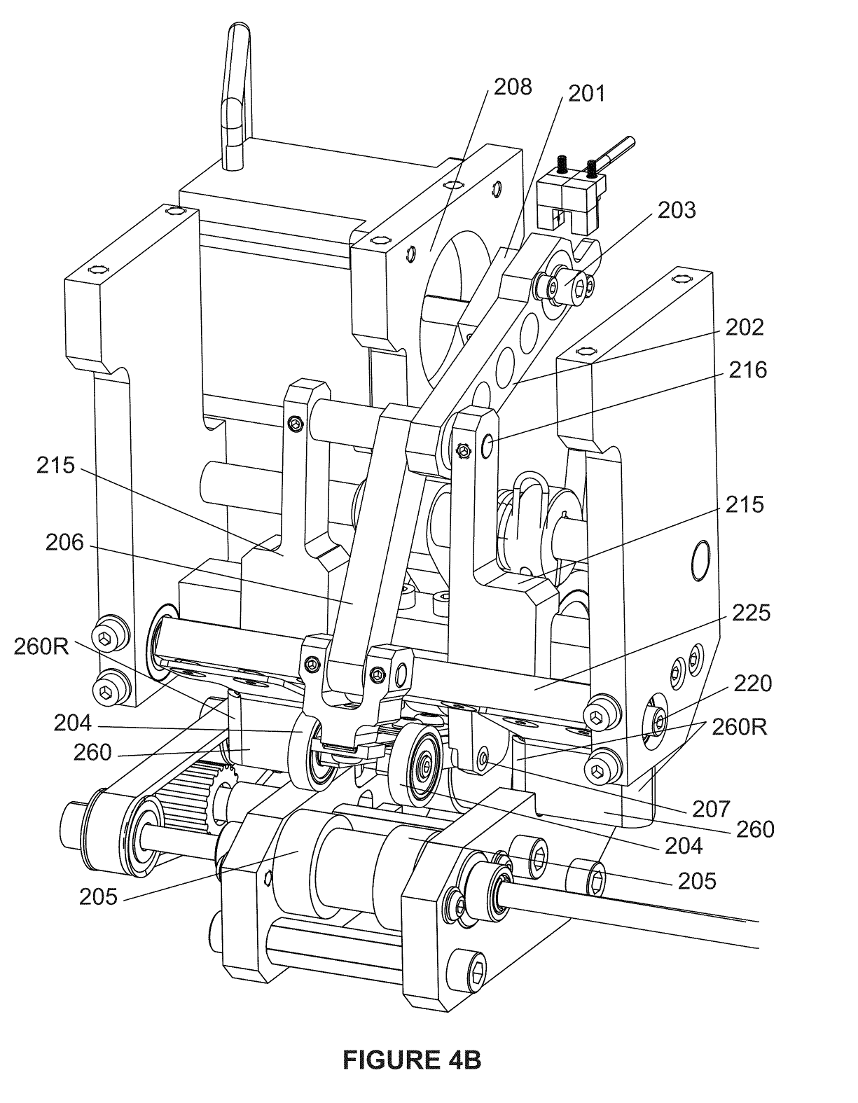

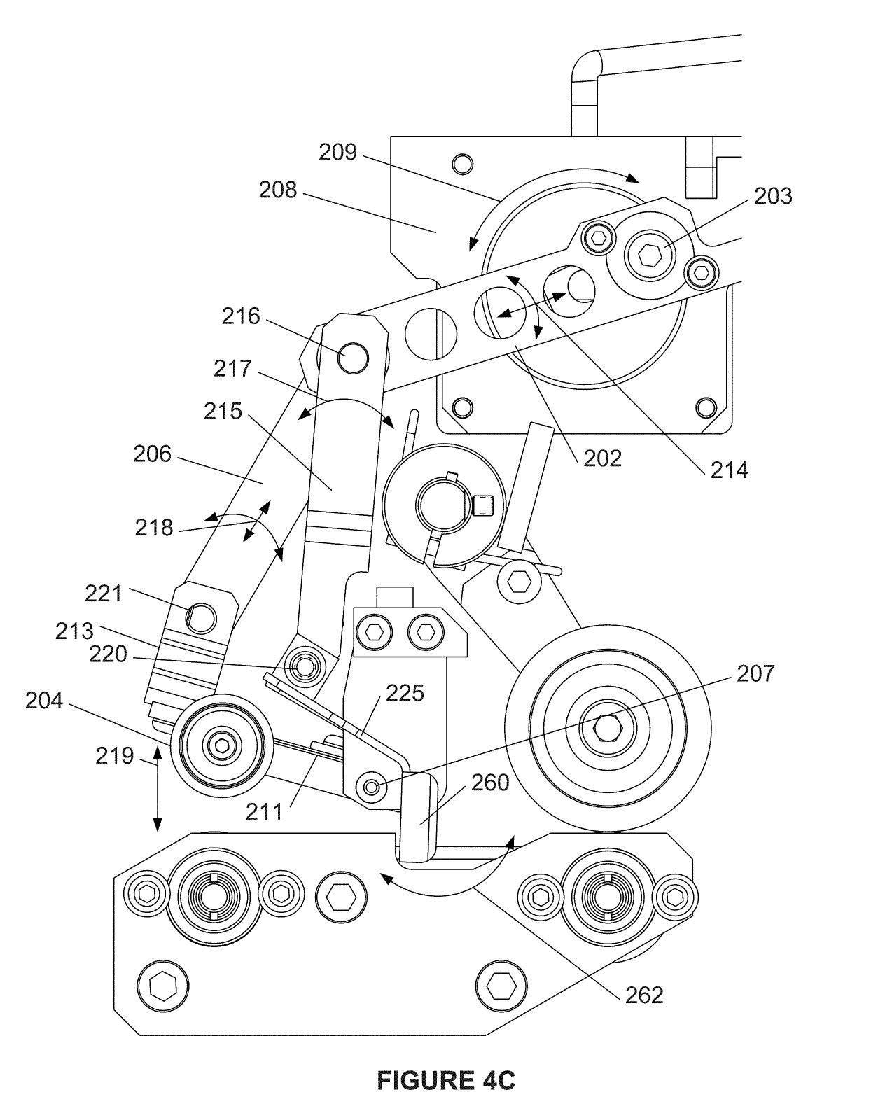

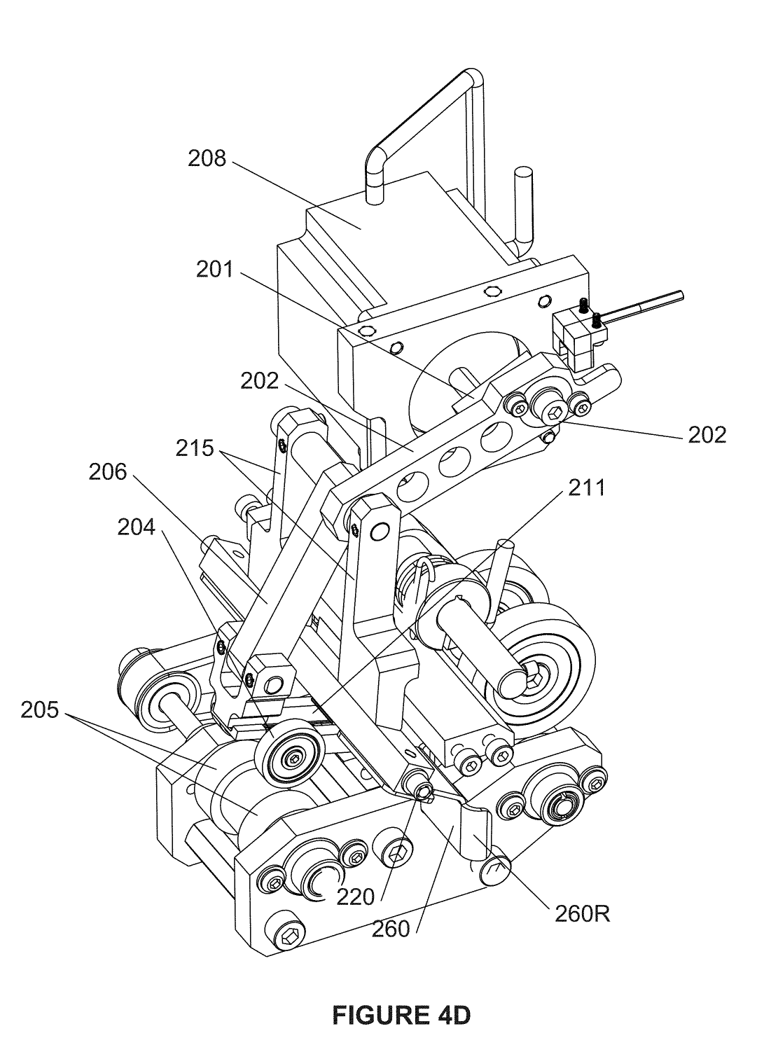

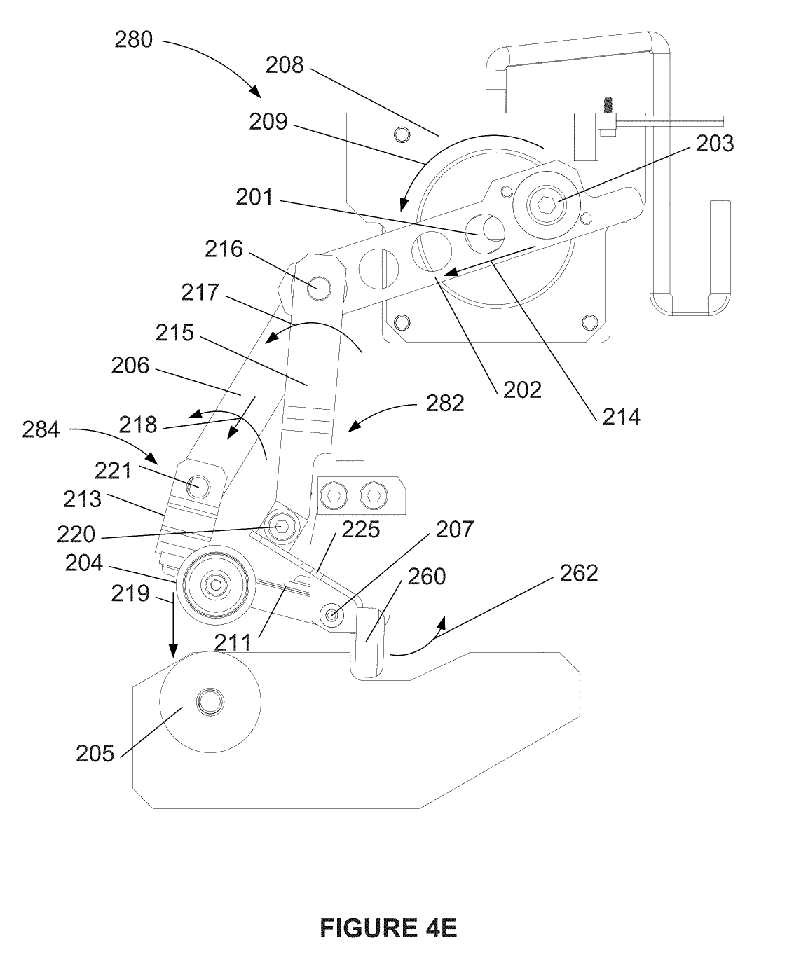

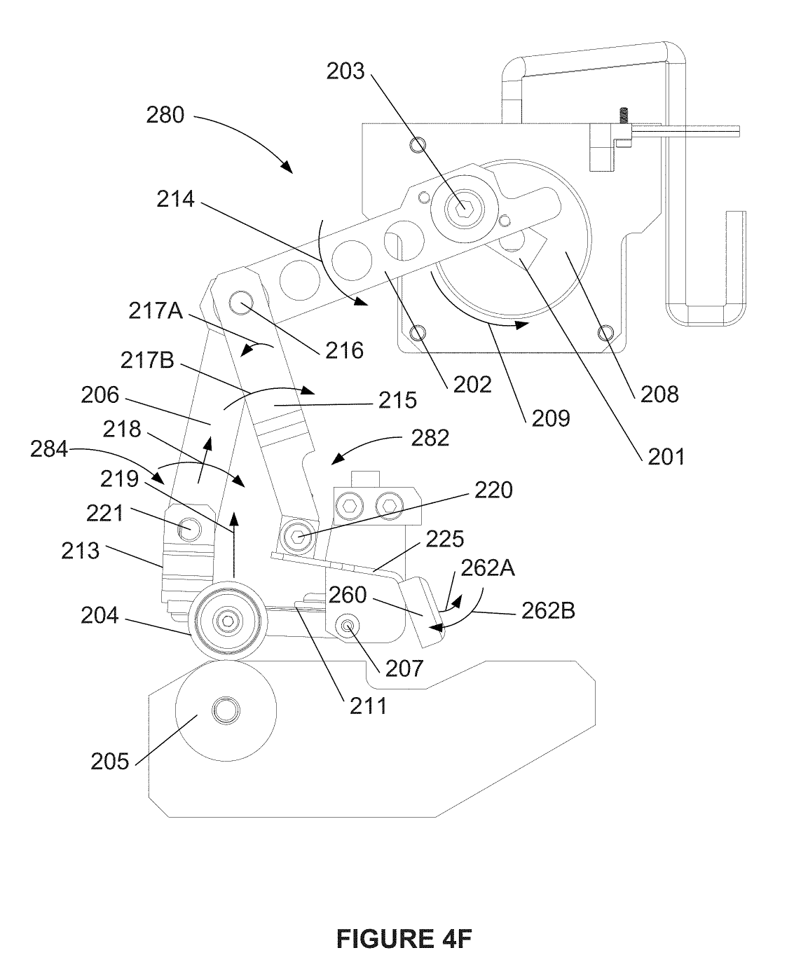

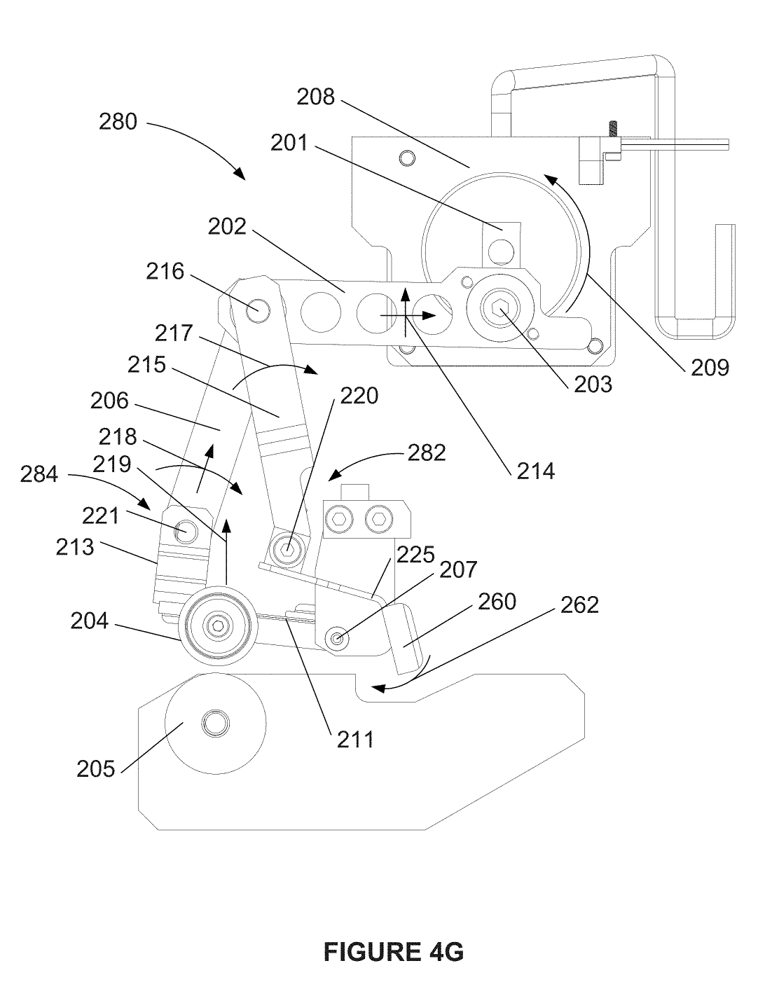

Still referring to FIG. 3, once insert stack 320 is transported to an end of insert transport plate 210, insert stack 320 enters an insert stager 35, where an insert stack 320 is held to be deposited onto envelope sheet 310. Insert stager 35 is located within merge region 40, where insert stack 320 merges with and is deposited on top of at least a portion of envelope sheet 310. At the transition between insert transport plate 210 and stager transport plate 233, the locomotion of insert stack 320 is transferred from being controlled by tabs 232 to one or more stager transport belts 234, which is configured to be located over at least a portion of the length of stager transport plate 233; at this transition point, stager transport belts 234 accelerate insert stack 320 away from tabs 232 to prevent “sniping” of the trail edge of insert stack 320 by the rotation of tabs 232 at the transition point. Stager transport belts 234 are configured to be inboard and/or outboard from tabs 232. Stager transport belts 234 are disposed to be on top of and in contact with insert stack 320, but in some embodiments, stager transport belts can be above and/or below insert stack 320. Insert stack 320 passes by one or more (e.g., a plurality of) insert side jogger rollers 242, which are set at a width corresponding to a width of a widest insert sheet (e.g., the first, or control, sheet, or any subsequently deposited sheet) in insert stack 320 and vibrate insert stack 320 to facilitate the front edge justification, and also to correct conditions where the inserts (e.g., 322 and 324) in insert stack 320 may be skewed relative to one another. In some embodiments, stepper motors, servo actuators, and the like, are used to ensure that both side jogger rollers 242 are in/out at the same time such that the insert stack 320 is vibrated effectively, rather than merely being shifted side to side. Additionally, a photocell may be used to determine the relative positions of the side jogger rollers at startup to ensure that their positions are sufficiently synchronized during operation. In some embodiments, stager transport belt 234 is configured to accelerate insert stack 320 along stager transport plate 233, such that the inserts of insert stack 320 become forward edge registered against the stop gate 260, as shown in FIG. 4a, within the insert stager 35. Once an insert stack 320 is held within insert stager 35, insert stack 320 is held in a substantially fixed position to be deposited onto envelope sheet 310 when triggered.

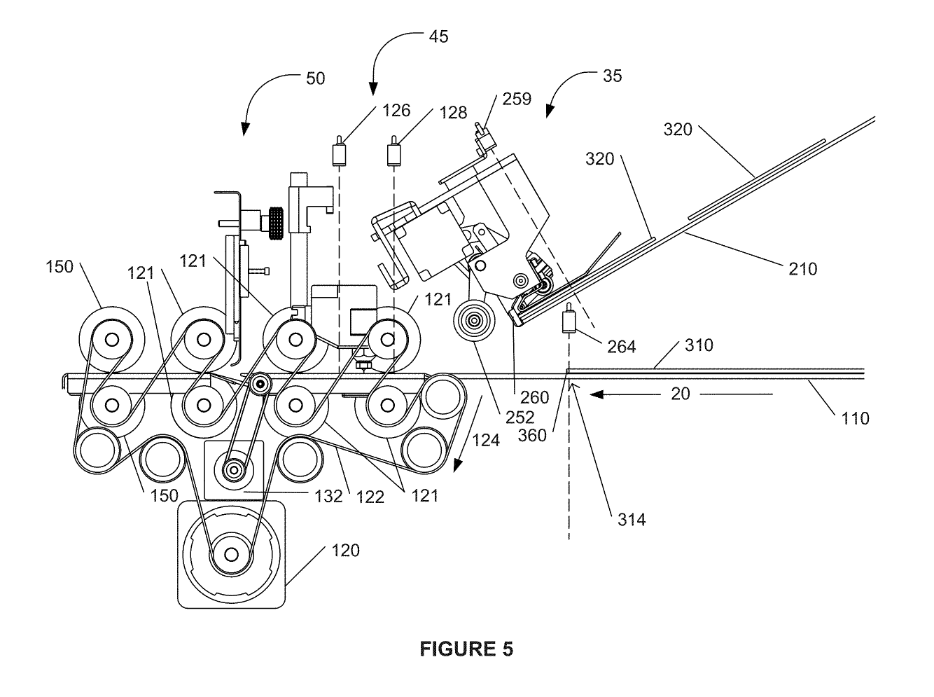

Primary transport path 1 is arranged vertically beneath insert transport path 2, such that primary transport path 1 is substantially parallel with insert transport path 2. In some embodiments, insert transport path 2 may be disposed above, below, beside, adjacent to, and/or at an angle (or any combination thereof) relative to primary transport path 1. As shown in the example embodiment of FIG. 3, envelope sheet(s) 310 moves along envelope transport plate 110 of envelope conveyor 111, in direction of travel 20. Envelope sheet 310 is side edge registered (e.g., right or left side edge) by envelope edge justifier 114, while also being rear edge registered by envelope conveyor belt tabs 112; in some embodiments, the side edge registering occurs simultaneous with the rear edge registering in the form a push pins moving through an angled ball registration device. In some embodiments, envelope edge justifier 114 can be omitted. After being side and/or rear edge registered, envelope sheet 310 moves into merge region 40, which will be discussed further in more detail for FIGS. 4A through 4G and in FIG. 5.

Insert stager 35 is a critical component of system 10, as it collects and stages inserts 322, 324 in a holding slot 240, and releases (e.g., ejects) the insert stack 320 onto envelope sheet 310, traveling adjacent to (e.g., underneath) insert stager 35 at the same speed as envelope sheet 310 moves along conveyor. This is a complex process that requires precise positioning of insert stack 320 on top of envelope sheet 310.

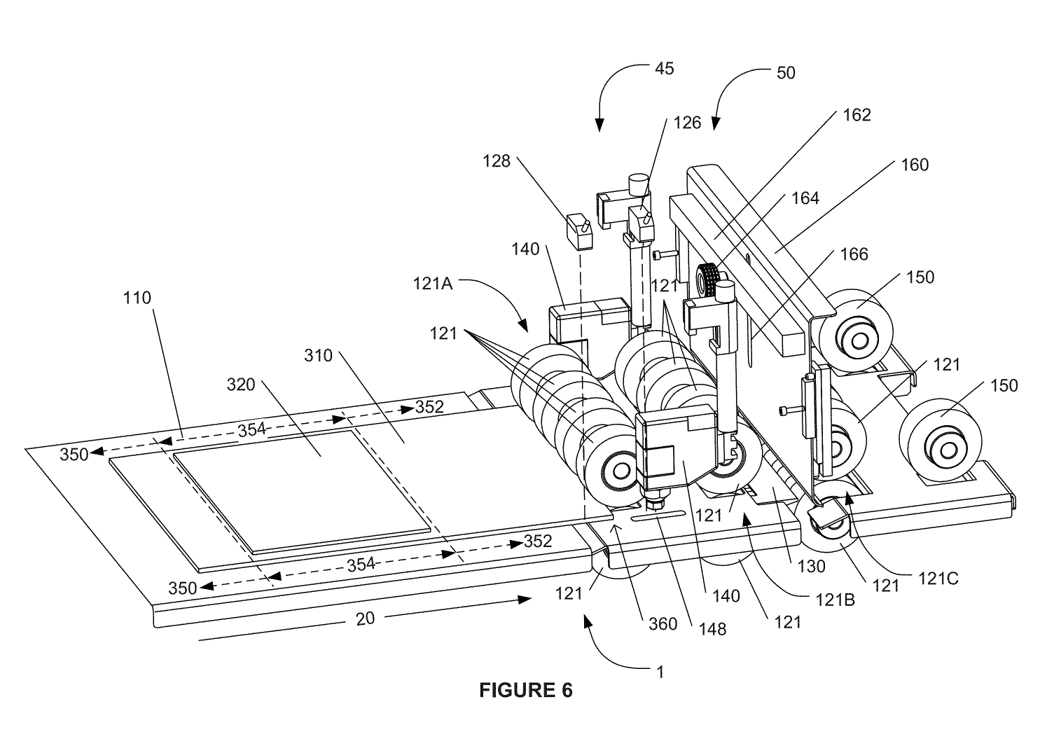

In some embodiments, it is advantageous to control dispensing of insert stack 320 onto envelope sheet 310 so that a relative position of insert stack 320 and envelope sheet 310 is maintained within a range of several millimeters (e.g., within 5 mm, within 3 mm, within 2 mm, or within 1 mm). Those having skill in the art will understand that the degree of precision in dispensing insert stack 320 onto envelope sheet 310 will also vary depending on the physical dimensions (e.g., size) of insert stack 320 relative to the insert region of the envelope (see, e.g., 354, FIG. 6). For example, where insert stack 320 is substantially a same size (e.g., within 5 mm, within 3 mm, within 2 mm, or within 1 mm) as the insert region of the envelope, it is much more critical to ensure precise dispensing of insert stack 320 onto envelope sheet 310 so that no portion of insert stack 320 extends beyond the envelope primary fold point (see, e.g., 366, FIG. 8), such that no portion of insert stack 320 is folded during formation of the mailpiece. However, when insert stack 320 is significantly smaller (e.g., smaller by at least 5 mm, 10 mm, 25 mm, etc.) than the insert region of envelope sheet 310, the positioning of insert stack 320 on envelope sheet 310 need not be as precise, allowing for wider variations in placement of insert stack 320 on envelope sheet 310. The lateral placement of insert stack 320 on envelope sheet 310 is of similar importance to ensure that no portion of insert stack 320 is dispensed into a region where the adhesive will be dispensed, in which case, the mailpieces created will be defective.

Where necessary, this precise positioning can be achieved by controlling a timing of the operation of insert stager 35 to dispense insert stack 320 the movement of envelope sheet 310 along primary transport path 1 and the one or more insert feeders 30. These functions are typically, according to the teachings of the prior art, accomplished using a variety of each of photocells, linear actuators, solenoids, motors, encoders, and complex control logic. According to the subject matter disclosed herein, system 10 achieves these functions in a cost effective manner, while still achieving a high throughput (e.g., as many as 15,000 mailpieces per hour) without mailpiece damage or high rates of malfunctions (e.g., from paper jams, misfires, misalignments, and the like). Here, however, insert stager 35 has a comparatively less complex control scheme, which employs a mechanical linkage system, generally designated 280 (see FIGS. 4E through 4G) to achieve the functionality needed for the operation of insert stager 35.

As can be seen in at least FIGS. 4A through 4G, insert stager 35 includes a complex mechanical linkage system 280 to control an output of insert stager 35. Mechanical linkage system 280 includes a motor 208, a plurality of linkages, or bars, such as crank arm 201, coupler linkage 202, stop gate rocker arm 215, idler rocker arm 206, insert idler linkage arm 213, stop gate connection bar 225, and insert idler support spring 211, and a plurality of pivot points, such as coupler bearing 203, pivot bearing 216, insert idler pivot bearing 221, idler bearing 207, and stop gate pivot bearing 220, about which the respective linkages of mechanical linkage system 280 rotate. In the arrangement shown in FIGS. 4E through 4G, motor 208, crank arm 201, and coupler linkages 202 are connected together to transfer a locomotive force from motor 208 to first and second linkage subassemblies 282 and 284, respectively. First and second linkage subassemblies 282 and 284 generate first and second motion profiles using the single input from motor 208, which is transmitted to the first and second linkage subassemblies 282 and 284 through pivot bearing 216, via crank arm 201 and coupler linkage 202.

First and second motion profiles are different from each other. In the embodiment shown, first motion profile is illustrated as stop gate travel path 262, which has a curved profile. Second motion profile is illustrated as insert idler roller travel path 219, which is substantially vertically oriented (e.g., having a radial component of motion as it rotates around statically fixed idler bearing 207), relative to stager transport plate 233. Depending on the travel paths desired for stop gate 260 and insert idler rollers 204, respectively, the components of mechanical linkage system 280 can be designed in any suitable fashion to produce the desired first and second motion profiles. The functionality of this mechanical linkage system 280 will be discussed in greater detail with respect to FIGS. 4E through 4G. The design is complex, yet yields the functionality needed for mailpiece enveloping at the cost point required. Maintenance also is reduced since all required movement is produced by a single motor 208. The insert stager 35 is configured for operation without an encoder being needed for positional detection or operation of the stager, via the mechanical linkage system 280 described herein.

Referring now to FIGS. 4A through 4D, detailed side and perspective views of insert stager 35 are shown. According to this embodiment and as shown in FIG. 4A, insert stack, generally designated 320, has two inserts, primary insert 322 and secondary insert 324. Insert stack 320 is held in place in holding slot, generally designated 240, within insert stager 35 by stop gate 260 until insert stager 35 is triggered to deposit insert stack 320 out of insert stager 35. Stop gate 260 can be one piece, two pieces (or more), and has, in some embodiments, a radiused portion 260R (e.g., having a radius of about 0.5 inches) at the front face of the stop gate 260 where the insert stack impacts the stop gate during accumulation of the inserts 322 and 324. Insert stack 320 is now front registered within holding slot 240, such that the leading edge of each insert sheet of insert stack 320 (e.g., both primary insert 322 and secondary insert 324) are both adjacent to and/or in direct contact with stop gate 260. As will be seen in FIG. 5, insert stager 35 is actually inclined with respect to gravity, such that both primary insert 322 and secondary insert 324 are front edge registered against stop gate 260. Insert stack 320 is also held between insert guide plate 235 and stager transport plate 233.

In the illustrations of FIG. 4A through 4D, primary insert 322, secondary insert 324, stager transport plate 233, and insert guide plate 235 are shown being physically separated from each other to provide added clarity of the view shown, but these elements will, at various points in time during normal operation, come into contact with one or more of these other structures. Cyclic movement of the components of the insert stager 35 are accomplished via translation of a single input (e.g., a rotary force output from motor 208) to drive distinctly different motion profiles of stop gate 260 and insert idler roller 204, respectively, via a complex mechanical linkage system 280 (see FIGS. 4E through 4G). This arrangement allows for a repeatable cyclic motion profile (e.g., a smooth sinusoidal motion), with a controlled motion profile at impact to allow for quieter operation, less impact force, less wear on components, less damage to mailpieces, and increased reliability of insert stager 35. The insert idler roller 204 moves sinusoidally over a controlled path, gradually increasing force (e.g., having an analog characteristic) on insert stack 320, while stop gate 260 also moves over a defined path without sudden (e.g., impulsive) motion. An example motion path for the mechanical linkage system 280 is shown in FIGS. 4E through 4G, which will be described in greater detail below.

Damage to the leading edge of insert stack 320 is minimized, starting at the transition of inserts 322, 324 from being driven by insert assembly belt tabs 232 onto stager transport plate 233, which is inclined with respect to gravity (see, e.g., FIG. 3). Inserts 322, 324 are driven along stager transport plate 233 by stager transport belts 234, which are, in some aspects, frictional drive belts. Stager transport belts accelerate inserts 322, 324 away from tabs 232 to prevent sniping of the rear edges thereof by tabs 232, then slows inserts 322, 324 to maintain an effectively constant speed along insert transport path 2, so that each insert stack 320 moves the same distance for every cycle of the machine. In some embodiments, programmable motors and/or one or more variable cam mechanisms can be used to produce a repeatable variability of the speed of insert stack 320. Inserts 322 and 324 are released from the friction belts after having traversed approximately half of the length of stager transport plate 233. Inserts 322, 324 then traverse the remainder of the length of stager transport plate 233, into holding slot 240, by momentum and the vibration created by insert side jogger rollers 242. This method results in a very gentle impact into the stop gate 260, hence no damage to the leading edges of inserts 322, 324 from striking stop gate 260. In some embodiments, stop gate 260 has, at each end thereof (e.g., adjacent to the outer edges of insert stack 320), a radiused portion 260R which prevents damage to the leading edges of inserts 322, 324 from striking stop gate 260. In some embodiments, where stop gate 260 comprises a plurality of separate portions, each end of each portion may have such a radiused portion 260R.

Damage is further reduced by having stop gate 260 move up and away from insert stack 320, as illustrated in FIGS. 4A and 4C by the motion profile of stop gate travel path 262, instead of dragging stop gate 260 across the leading edge of insert stack 320, as is commonly done by prior art designs, where stop gates are moved vertically, and are thus dragged across the leading edge of insert stack 320. Stop gate travel path 262 facilitates the smooth ejection of insert stack 320 from holding slot 240 onto envelope conveyor 111 by moving away from insert stack 320 as insert idler roller 204 engages against insert stack 320 and compresses insert stack 320 against insert drive roller 205. Variations in insert stack 320 ejection onto envelope conveyor 111 are a function of the frictional characteristics of the paper from which insert stack 320 is made, and the looseness of insert stack 320 within holding slot 240. These variations in the ejection process, are accommodated by stop gate travel path 262, further reducing the possibility of damage to the leading edges of inserts 322, 324.

In the embodiment shown, insert stager 35 operates through use of a complex mechanical linkage system, generally designated 280, that is commonly driven by a single locomotive source. While the complex mechanical linkage system 280 of insert stager 35 is advantageous for the reasons noted hereinabove, in other embodiments, mechanical linkage system 280 can be replaced with any other suitable combination of mechanical linkage(s), as will be understood by those having ordinary skill in the art and, furthermore, may include two separately driven mechanical linkage systems. Non-limiting examples of such other possible mechanical linkages include pneumatic actuators, which suffer from a lack of feedback control, electromagnetic actuators, which generally require the use of mechanical snubbers/dampers to soften the impulsive nature of the impact (e.g., the driven motion), and a servo motor to control motion, e.g., a linear motion controlled servo-driven actuator, which suffers from excessive cost. A locomotive force is transmitted, here in a rotary fashion, from motor 208 into a crank arm 201, which is fixedly connected to a first (e.g., proximal) end of a coupler linkage 202 via a coupler bearing 203, which rotatably attaches coupler linkage 202 to crank arm 201. Coupler linkage 202 simultaneously transmits the rotary movement of crank arm 201 to idler rocker arm 206 and stop gate rocker arm 215, both of which are connected at their first (e.g., proximal) ends to the second (e.g., distal) end of coupler linkage 202 at pivot bearing 216.

Idler rocker arm 206 is connected at its second (e.g., distal) end to one or more (e.g., two) insert idler rollers 204 to control the vertical movement thereof and is pivotably connected to idler pivot point 207 by an insert idler roller pivot arm 212, which is fixed and and rotatable about idler pivot point 207. Insert guide plate 235 is formed in the shape of a leaf spring, but is not driven by motor 208. Instead, insert guide plate 235 is flexibly attached to the external housing of insert stager 35 and is configured to guide insert stack 320 into a staged position against stop gate 260. A slot is formed through the thickness of insert guide plate 235 at least in a position vertically underneath insert idler rollers 204, such that insert idler rollers 204 can move substantially vertically to press insert stack 320 against one or more (e.g., two) insert drive rollers 205 for ejection of insert stack 320 from insert stager 35. These insert idler rollers are shown herein being disposed such that substantially all of insert drive rollers 205 are disposed beneath stager transport plate 233, with only a portion of insert drive rollers 205 protruding beyond the upper surface of stager transport plate 233 and into holding slot 240. In such embodiments, insert idler rollers 204 pass beyond the bottom surface of insert guide plate 235, into holding slot 240, to contact an upper surface of insert stack 320 (e.g., an upper surface of secondary insert 324), thus compressively “sandwiching” insert stack 320 between insert idler rollers 204 and insert drive rollers 205 so that insert drive rollers 205 impart a driving ejection force to insert stack 320.

In the embodiment shown in FIGS. 4A through 4D, stop gate rocker arm 215 is connected, at its first (e.g., proximal) end, to coupler linkage 202 via pivot bearing 216 and, at its second (e.g., distal) end, to a stop gate pivot bearing 220. Pivot bearing 216 is configured to move within insert stager 35, whilst stop gate pivot bearing 220 is substantially rigidly fixed at a position within insert stager 35 (e.g., at or through a side housing of insert stager 35), such that stop gate rocker arm 215 is not vertically displaceable, but instead is only rotatably movable around stop gate pivot bearing 220. Stop gate connection bar 225 is rotatably movable around, at a first (e.g., proximal) end thereof, stop gate pivot bearing 220, and is either fixedly attached to (e.g., by compression, such as a screw and nut arrangement) or integrally formed as part of (e.g., in a single piece with) stop gate rocker arm 220 at a second (e.g., distal) end thereof. Stop gate 260 is attached to and/or integrally formed as a single piece with stop gate connection bar 225. In some embodiments, stop gate rocker arm 215, stop gate connection bar 225, and stop gate 260 form a single unitary structure (e.g., are integral, monolithic, and/or formed as a single piece). In some other embodiments, one or more of stop gate rocker arm 215, stop gate connection bar 225, and stop gate 260 are formed integrally with one or more of the other structures. In still other embodiments, each of stop gate rocker arm 215, stop gate connection bar 225, and stop gate 260 are formed discretely from each other and are substantially rigidly attached to each other in the manner described above.

Insert stager has a stop gate optical sensor 259, which is configured to detect the presence of an insert stack 320 positioned within insert stager 35, such that stop gate 260 will not be actuated from the first (e.g., closed) position to the second (e.g., open) position when no insert stack 320 is detected within insert stager 35. A second set of drive and idler rollers, merge drive rollers 250 and merge idler rollers 252, are arranged external to stop gate 260. In some embodiments, merge drive rollers 250 and merge idler rollers 252 are configured to provide a secondary accelerative force to insert stack 320, so that insert stack 320 merges onto a designated envelope sheet at substantially a same speed as the envelope sheet transport speed.

Referring now to FIGS. 4E through 4G, an example embodiment of a mechanical linkage system, generally designated 280, for an insert stager is shown at several positions of actuation thereof for the ejection of insert sheets. As seen in FIG. 4E, motor 208 provides (e.g., imparts) a locomotive rotary force to crank arm 201 in a direction indicated by motor direction 209 to drive the motion of stop gate 260, through a first linkage subassembly, generally designated 282, along a first motion profile defined by stop gate travel path 262 to control an ejection of insert stack (see, e.g., 320, FIGS. 4A through 4D) in a precisely timed and controlled manner onto an envelope sheet 310. The movement of crank arm 201 along motor direction 209 also drives an oscillatory substantially vertically downward movement (e.g., having a radial component as it rotates around idler bearing 207) of insert idler rollers 204, through a second linkage subassembly, generally designated 284, along a second motion profile defined by insert idler roller travel path 219.

In the embodiment shown in FIGS. 4A through 4G, but specifically in FIGS. 4E through 4G, first linkage subassembly 282 is configured, via its connection to coupler linkage 202 at pivot bearing 216, to receive the single input from motor 208 through crank arm 201, coupler bearing 203, coupler linkage 202. First linkage subassembly 282, in the embodiment shown, includes stop gate rocker arm 215, stop gate pivot bearing 220, stop gate connection bar(s) 225, and stop gate 260. Components may be added, modified, and/or omitted to achieve any of a plurality of desired motion profile outputs, as will be understood by those having ordinary skill in the art. Stop gate rocker arm 215 is rotatably connected at a first end thereof to coupler linkage 202 at pivot bearing 216; as such, stop gate rocker arm 215 is configured to be driven, via coupler linkage 202 and pivot bearing 216, through the stop gate rocker arm travel paths 217, which varies according to a stage of actuation of mechanical linkage system 280, three positions respectively being illustrated in FIGS. 4E, 4F, and 4G. Stop gate rocker arm 215 is rotatably (e.g., pivotably) connected at its second end to stop gate pivot bearing 220, which is spatially fixed (e.g., incapable of translatory movement during operation). Thus, because stop gate pivot bearing 220 is statically fixed (e.g., allows only rotary motion thereabout), stop gate rocker arm travel path 217 has a shape of an arc, as stop gate rocker arm 215 is only capable of rotary motion about stop gate pivot bearing 220. One or more stop gate connection bars 225 are each rigidly connected at the respective first ends thereof to stop gate rocker arm 215, such that the rotary motion of stop gate rocker arm 215 around stop gate pivot bearing 220 causes a corresponding (e.g., identical) angular rotation of the one or more stop gate connection bars 225 around stop gate pivot bearing 220. In some embodiments, the one or more stop gate connection bars 225 and/or the stop gate rocker arm 215 may be connected to an intermediate structure that itself is fixed to (e.g., allowing rotary motion about) stop gate pivot bearing 220. Stop gate 260 is connected to (e.g., integrally or removably) a second end of the one or more stop gate connection bars 225 and is arranged at an angle relative to a main portion of the one or more stop gate connection bars 225, so that stop gate 260 can be arranged substantially orthogonal to (e.g., within 15°, within 10°, within 5°, within 2°, or within 1°) the plane defined by stager transport plate (see, e.g., 233, FIG. 4C) while the one or more stop gate connection bars 225 are arranged at a second, non-orthogonal, angle.

In the embodiment shown in FIGS. 4A through 4G, but specifically in FIGS. 4E through 4G, second linkage subassembly 284 is configured, via its connection to coupler linkage 202 at pivot bearing 216, to receive the single input from motor 208 through crank arm 201, coupler bearing 203, coupler linkage 202. Second linkage subassembly 284, in the embodiment shown, includes idler rocker arm 206, insert idler pivot bearing 221, insert idler linkage arm 213, insert idler roller 204, insert idler roller support spring 211, and idler pivot 207. Components may be added, modified, and/or omitted to achieve any of a plurality of desired motion profile outputs, as will be understood by those having ordinary skill in the art. Idler rocker arm 206 is rotatably connected at a first end thereof to coupler linkage 202 at pivot bearing 216; as such, idler rocker arm 206 is configured to be driven, via coupler linkage 202 and pivot bearing 216, through the idler rocker arm travel path 218, which has rotary and translatory components and the particular directions of which vary according to a stage of actuation of mechanical linkage system 280, three positions respectively being illustrated in FIGS. 4E, 4F, and 4G. Idler rocker arm 206 is rotatably (e.g., pivotably) connected at its second end to insert idler linkage arm 213 at insert idler pivot bearing 221. In this embodiment, insert idler linkage arm 213 is generally “L” shaped and is a rigid structure that will not deform (e.g., will only elastically deform, without yielding in plastic deformation) during normal use. Insert idler linkage arm 213 and idler rocker arm 206 are able to rotate relative to each other at insert idler pivot bearing 221. As coupler linkage 202 drives idler rocker arm 206 downwards and in a counterclockwise direction, insert idler linkage arm 213 rotates in the same counterclockwise direction around idler pivot 207, which is rigidly fixed to the insert stager (e.g., at a housing thereof). Insert idler roller 204 is rotatably connected to insert idler linkage arm 203 and is positioned such that, as insert idler linkage arm 203 rotates in the counterclockwise direction about idler pivot 207, insert idler roller(s) 204 will be substantially vertically aligned on top of (e.g., sufficiently to impart the compressive force to reliably dispense the insert stack from the insert stager, as those having ordinary skill in the art will appreciate) insert drive roller(s) 205. Insert idler roller support spring 211 provides a spring force to insert idler linkage arm 213 that is in the same counterclockwise direction with respect to idler pivot 207, in order to prevent bounding or stuttering of insert idler roller(s) 204 vertically away from insert drive roller(s) 205 as insert idler roller(s) 204 is driven downwards to apply the compressive force to the insert stack be engaging with insert drive roller(s) 205.

Accordingly, through mechanical linkage system 280 described herein, a single input is used to produce two distinct motion profiles that are synchronized (e.g., simultaneous) with each other, each of the single input, the first motion profile, and the second motion profile having different aspects of motion.

As such, in the position illustrated in FIG. 4E, insert idler rollers 204 and stop gate 260 are in their respective first positions. When insert stager 35 is triggered to eject an insert stack 320, crank arm 201 rotates along motor direction 209 to a second position, which is substantially diametrically opposite to the position shown in FIG. 4E. An intermediate position between the first and second positions is shown in FIG. 4F. While motor direction 209 is shown in a counter-clockwise direction, crank arm 201 can be rotated in either clockwise or counterclockwise directions by motor 208.

As crank arm 201 moves from the first position in FIG. 4E towards the second position, passing through the intermediate position shown in FIG. 4F, the mechanical linkage system is driven to produce a movement of idler rocker arm 206, which has both rotational and linear aspects along idler rocker arm travel path 218, as shown in FIG. 4E. As idler insert idler rollers 204 along idler rocker arm travel path 218 to a second position of the one or more insert idler rollers 204, which has both radial and vertical components of motion, and insert idler roller travel path 219, respectively. Simultaneously, stop gate rocker arm 215 pivots radially about stop gate pivot bearing 220, causing a corresponding (e.g., proportional) rotational movement of stop gate connection bar 225 and stop gate 260, generally along stop gate travel path 262, to the second position of stop gate 260. As such, stop gate 260 is actuated to the second (e.g., open) position while insert stack 320 is compressively engaged between insert drive rollers 205 and insert idler rollers 204, resulting in imparting the rotary drive force of insert drive roller 205 to insert stack 320, causing the ejection of insert stack 320 out of insert stager 35 while stop gate 260 is in the second (e.g., open) position. Insert idler rollers 204 move in an approximately vertical direction (e.g., relative to the plane defined by holding slot 240) downward from the up position, distinguished by the closed stop gate 260. Insert idler linkage arm 213 is connected at a first end to idler rocker arm 206 and at a second end to idler pivot 207. Insert idler linkage arm 213 also has a substantially rigid construction to limit flexure thereof as idler rocker arm 206 is driven vertically and rotationally by the connection thereof to coupler linkage 202 at pivot bearing 216. Insert idler roller support spring 211 connects insert idler linkage arm 213 to idler pivot 207. Idler rocker arm 206 is connected to insert idler linkage arm 213 at insert idler pivot bearing 221. Insert idler roller support spring 211 design parameters are selected to prevent the insert idler 204 from bouncing upon impact with the top side of insert stack 320. Selecting too weak of a spring force will result in the insert idler roller 204 bouncing upon contact, which can prevent the continuous ejection of insert stack 320 from insert stager 35, as the ejection force transmitted to insert stack 320 by insert drive roller 205 will be intermittently decoupled from insert stack 320 when insert idler roller 204 bounces away from insert drive roller 205. Selecting an insert idler roller support spring 211 that is too strong can cause a binding action, which can prevent the continuous ejection of insert stack 320 from insert stager 35. In either case, when an insert idler roller support spring is selected which has an incorrect spring force, insert stack 320 may not be positioned correctly on envelope sheet 310 after ejection of insert stack 320 from insert stager 35, resulting in a system malfunction (e.g., a paper jam) or defective mailpiece.

FIG. 4E shows a first position of the components of the mechanical linkage system, such that insert idler roller 204 is spaced apart from insert drive roller 205 and stop gate 260 is in a closed position. In the example embodiment shown, motor 208 drives the crank arm 201 in the direction of motor direction 209 to the position shown in FIG. 4F. As shown in FIG. 4F, insert idler roller 204 is in contact with insert drive roller 205 to impart the rotational driven motion of insert drive roller 205 to an insert stack, while stop gate 260 is in an open position to allow the dispensing of an insert stack from insert stager.

Continuing on to the second intermediate position of FIG. 4G, motor 208 is driven in the direction of motor direction 209, as indicated in FIG. 4F. This further motion moves through the second (e.g., fully extended) positions of the mechanical linkage system, such that, as the mechanical linkage system is driven from the position shown in FIG. 4F to the position shown in FIG. 4G, stop gate rocker arm 215 initially moves in the direction indicated by stop gate rocker arm path 217A, before reversing the direction of travel along stop gate rocker arm path 217B. This movement is also reflected in the movement of stop gate 260, which initially is driven in the direction of stop gate travel path 262A, before reversing the direction of travel of stop gate 260, as indicated by stop gate travel path 262B. However, because insert idler roller 204 is already in contact with insert drive roller 205, the movement of coupler linkage does not cause any substantial further movement of insert idler roller 204, but instead this motion is accommodated by additional bending of insert idler support spring 211 relative to idler rocker arm 206 and insert idler linkage arm 213 at insert idler pivot bearing 221.

FIG. 4G shows a second intermediate position of the components of mechanical linkage system, such that insert idler roller 204 is separated from insert drive roller 205 and, as crank arm 201 is rotated in the direction of motor direction 209, insert idler roller 204 moves substantially vertically away from (e.g., having a radial component as it rotates around idler bearing 207) insert drive roller 205, this substantially vertical movement being indicated by insert idler roller travel path 219, while idler rocker arm 206 moves and/or rotates in the directions indicated by idler rocker arm travel path 218. As crank arm 201 and coupler linkage 202 are driven along the direction of motor direction, stop gate rocker arm 215 rotates in the direction of stop gate rocker arm path 217, which causes a corresponding (e.g., proportional) rotation of stop gate 260 in the direction indicated by stop gate travel path 262. As such, after the motion path indicated in FIG. 4G occurs, the mechanical linkage system will be in (e.g., pass through) substantially the first position illustrated in FIG. 1.

Stop gate optical sensor 259 is configured to detect when insert stack 320 is no longer present and to send an electronic signal that initiates a rotary movement of crank arm 201 to the first position, as shown in FIGS. 4A through 4D, such that one or more (e.g., two) insert idler rollers 204 vertically move away from one or more (e.g., two) insert drive rollers 205, and stop gate 260 rotates back to the first (e.g., closed) position shown in FIGS. 4A through 4D. Crank arm 201 can be configured to rotate about a full 360° or can be configured to rotate only over substantially half (e.g., approximately 180°) of a circular revolution in moving between the first and second positions.

As is shown in FIG. 4C, stop gate 260 moves radially along stop gate travel path 262, as is controlled by the rotary movement of crank arm 201, via a travel of stop gate rocker arm 215 along stop gate rocker arm path 217, which is shown as pivoting radially around stop gate pivot bearing 220. Stop gate 260 is shown in its first position in FIGS. 4A through 4D, while the second position of stop gate lies at the opposite end of stop gate travel path 262 (see, e.g., other end of double arrow in FIGS. 4A and 4C). Since stop gate rocker arm 215 is pivotably fixed at a distal end at stop gate pivot bearing 220, as crank arm 201 rotates about motor 208, the movement of stop gate rocker arm 215 along stop gate rocker arm travel path 217 drives stop gate 260 to radially pivot around stop gate pivot bearing 220 through the connection of stop gate 260 and stop gate connection bar 225 to stop gate pivot bearing 220. Similarly, because both idler rocker arm 206 and stop gate rocker arm 215 are connected to coupler linkage 202 at a single pivotable connection point (e.g., pivot bearing 216), idler rocker arm 206 moves at substantially a same frequency as the stop gate rocker arm 215, such that idler rollers 204 are not engaged against drive rollers 205 (e.g., are in their first position) when stop gate 260 is in the position (e.g., the first position) shown in FIG. 4C. The complex motion described hereinabove can be, in some embodiments, accomplished by a single revolution e.g., around substantially 360°) of motor 208, thus reducing the control complexity needed for motor 208. In some other embodiments, motor 208 can be controlled to rotate reciprocally (e.g., back-and-forth) through less than a full revolution, such as, for example, approximately 180°.

Referring now to FIG. 5, an insert stack 320 is disposed within insert stager 35, prepared for ejection onto envelope sheet 310, which is moving in direction of travel 20 along envelope transport plate 110. In the respective positions of the elements in the embodiment shown, envelope sheet 310 is in the dispensing position, generally designated 314, and, in this position, envelope sheet 310 is detected by merge optical sensor 264, which triggers insert stager 35 to eject insert stack 320 from insert stager 35, as described above in the description of FIG. 5. Merge drive roller 250 is omitted from this view for clarity. Envelope sheet 310 is continuously moved at a substantially constant speed as insert stack 320 is ejected from insert stager 35 and deposited on top of envelope sheet 310. In some embodiments, a computer (e.g., 100, FIG. 1) is configured to use the operational parameters, such as, for example, envelope sheet transport speed, signal latency of merge optical sensor 264, the dimensions (e.g., length and/or width) of envelope sheet 310, and/or the dimensions (e.g., length and/or width) of insert stack 320 to determine a precise timing setting for ejection of insert stack 320, measured from the moment that merge optical sensor detects the leading edge 360 of envelope sheet 310, such that insert stacks 320 are precisely and accurately deposited onto a designated area of envelope sheets 310. In some embodiments, the timing for the delay between detection of the leading edge 360 of envelope sheet 310 and the ejection of insert stack 320 from insert stager 35 can be manually controlled, at least partially, by an operator. In some such instances, a computer sets an initial timing delay value based on one or more of the operational parameters noted above, and an operator is capable of fine-tuning (e.g., changing) this initial timing delay value based on performance of system 10.

Referring now to FIG. 6, envelope sheet 310 and insert stack 320 have been merged and the leading edge 360 of envelope sheet 310 is continuing to move at a substantially constant speed along envelope transport plate 110, entering adhesive application region 45. For clarity, insert stager 35 has been omitted from this view. While in adhesive application region 45, an adhesive (e.g., a pressure-sensitive bonding glue) will be applied, using adhesive applicators 140, over at least portions of the lateral sides of envelope sheet 310, outside of insert stack 320. Waste adhesive reservoirs 148 are disposed underneath each adhesive applicator 140, to catch any excess adhesive that might otherwise be transferred to other portions of system 10, causing defective mailpieces.

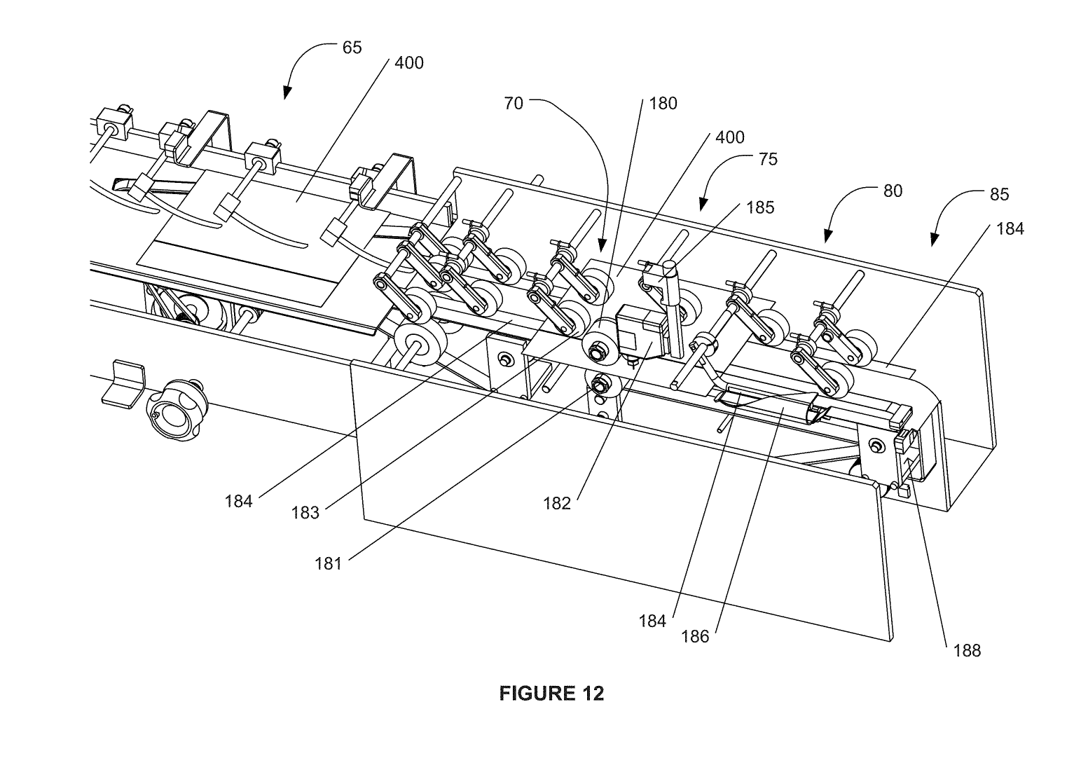

In this view, insert stack 320 is positioned on envelope sheet 310 so as to define, on one side of insert stack 320, a flap region 350, and, on a second side of insert stack 320, a back region 352. While it is contemplated that actual lines or creases may be formed on envelope sheet 310 along the broken lines defining flap region 350 and back region 352, in the embodiment shown, the broken lines are phantom lines that are not in any way physically represented on envelope sheet 310. As will be discussed further regarding other figures, the back of a finished mailpiece will be formed from the portion of envelope sheet 310 within back region 352, while the flap of a finished mailpiece will be formed from the portion of envelope sheet 310 within flap region 350. While the regions shown correspond to a “traditional” envelope shape, with back region 352 being significantly larger (e.g., 200% or more) than the area assigned to flap region 350, the sizes for the regions can be selected to have any size of back region 352 and flap region 350 by, for example, adjusting the position of insert stack 320 relative to the length of envelope sheet, adjusting a position (e.g., a height) of fold plate stop bar 162, and/or adjusting or changing a configuration of the plow folder guide, the plow folder, and/or the flap sealer. (see, e.g., 184, 186, and 188, respectively, in FIG. 12.)

Once transitioned into adhesive application region 45, envelope sheet 310 will be engaged by and/or between a plurality of transport rollers 121. The plurality of transport rollers 121 are configured to move envelope sheet 310 and insert sheet 320 at the same speed at which envelope sheet 310 moves in, for example, merge region (e.g., 40, FIG. 3). In some embodiments, the transport rollers 121 may be configured to move envelope sheet 310 at a slower or faster speed (e.g., to decelerate and/or accelerate envelope sheet 310) than an entry speed of envelope sheet 310 into transport rollers 121. In the embodiment of FIG. 6, envelope sheet 310 and insert stack 320 are compressively engaged between opposing transport rollers 121 on top and bottom sides of envelope sheet 310 and insert stack 320. Because leading edge 360 of envelope sheet 310 enters transport rollers 121 first, insert stack 320 enters transport rollers 121 after and on top of envelope sheet 310. In some embodiments, a single set of transport rollers 121 may be disposed above envelope sheet 310. Referring back to FIG. 5, each of the plurality of transport rollers 121 is driven by transport roller drive motor 120.

In the embodiments shown in FIG. 5, three successive sets of transport rollers 121, each set of transport rollers having a plurality of transport rollers 121, are located serially along primary transport path 1, such that leading edge 360 of envelope sheet 310 enters a first set of a plurality of transport rollers, generally designated 121A, then enters a second set of a plurality of transport rollers, generally designated 121B, and is then vertically diverted into a buckle folder system, generally designated 50. Envelope sheet 310 is then pushed and/or drawn into a third set of a plurality of transport rollers, generally designated 121C in order to create the bottom edge of the mailpiece being formed (see, e.g., FIG. 8). In some embodiments, one or more of the sets of a plurality of rollers 121A, 121B, 121C may have only a single transport roller 121 and/or may be omitted entirely.

Each of the sets of a plurality of transport rollers 121A, 121B, 121C may be controlled independently or by a single motor. In the embodiment shown, each transport roller 121 rotates at substantially the same speed as each other transport roller 121. In the embodiment shown, each of the plurality of transport rollers 121 and each of the plurality of adhesive sealing rollers 150 are drive by a roller drive belt 122. In some embodiments, a plurality of such roller drive belts 122 may be provided.

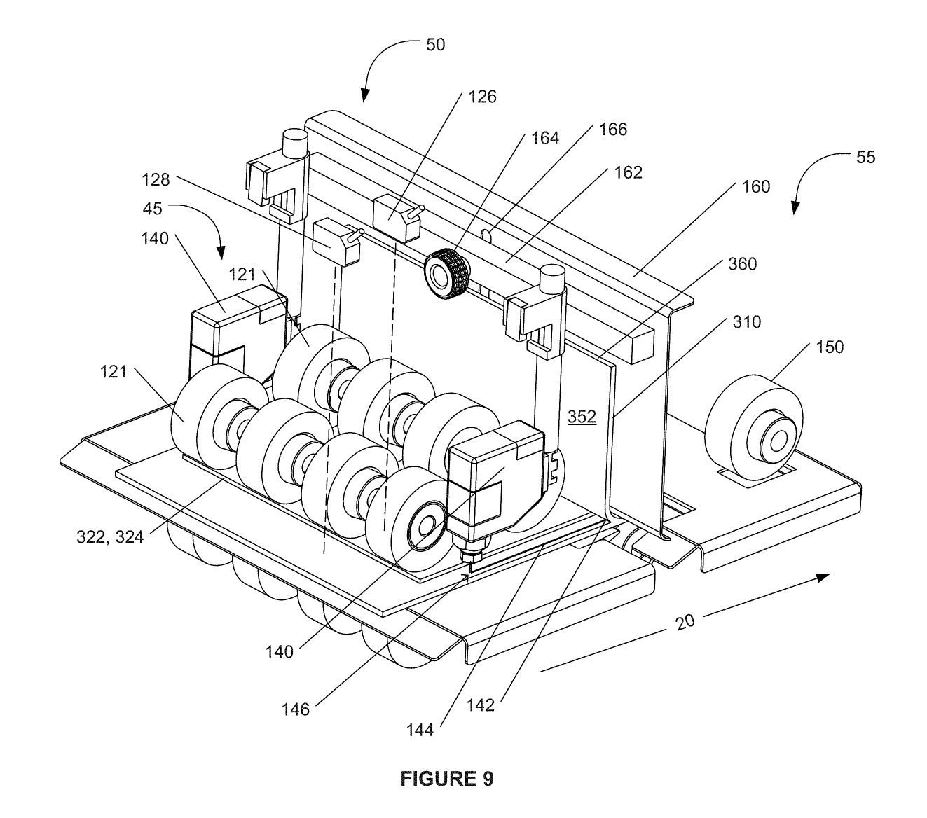

As is shown in FIG. 6, a first adhesive optical sensor 128 is disposed vertically above primary transport path 1 such that leading edge 360 of envelope sheet 310 is detected by first adhesive optical sensor 128 before being detected by a diverter optical sensor 126. The behavior of first adhesive optical sensor 128 will be described in greater detail with respect to FIG. 9. In this embodiment, when leading edge 360 is detected by diverted optical sensor 126, fold diverter 130 is actuated to a diverted position, so that leading edge 360 is vertically diverted to run along fold plate 160. Fold diverter 130 is actuated by fold diverter motor (see, e.g., 132, FIG. 5) based on an electrical signal received from diverter optical sensor 126. In some embodiments, the signal from diverter optical sensor 126 is transmitted directly to the fold diverter motor. In other embodiments, the signal from diverter optical sensor 126 is transmitted to computer 100, which can apply further operational parameters (e.g., a delay, a duration of actuation, a height of actuation, etc.) to the signal, and then transmit the signal to the fold diverter motor. In some embodiments, when diverter optical sensor 126 does not detect an envelope sheet 310 within an anticipated time period window (e.g., a time period window based on an operational throughput of system 10), computer 100 or PLC components can instruct adhesive applicators 140 to not dispense any adhesive (or withhold instructions to apply the adhesive) and, furthermore, keep the fold diverter 130 in the rest (e.g., non-actuated) position so that any envelope sheet 310 that arrives outside of the anticipated time period window will not be diverted onto fold plate 160, but will instead be minimally processed and output, either to be discarded to fed through system 10 again. In some embodiments, system 10 may include a divert bin for such defective envelope sheets, so that they will be diverted upstream of any further processing steps after buckle folder system 50, or at some other point between buckle folder system 50 and output section 90.

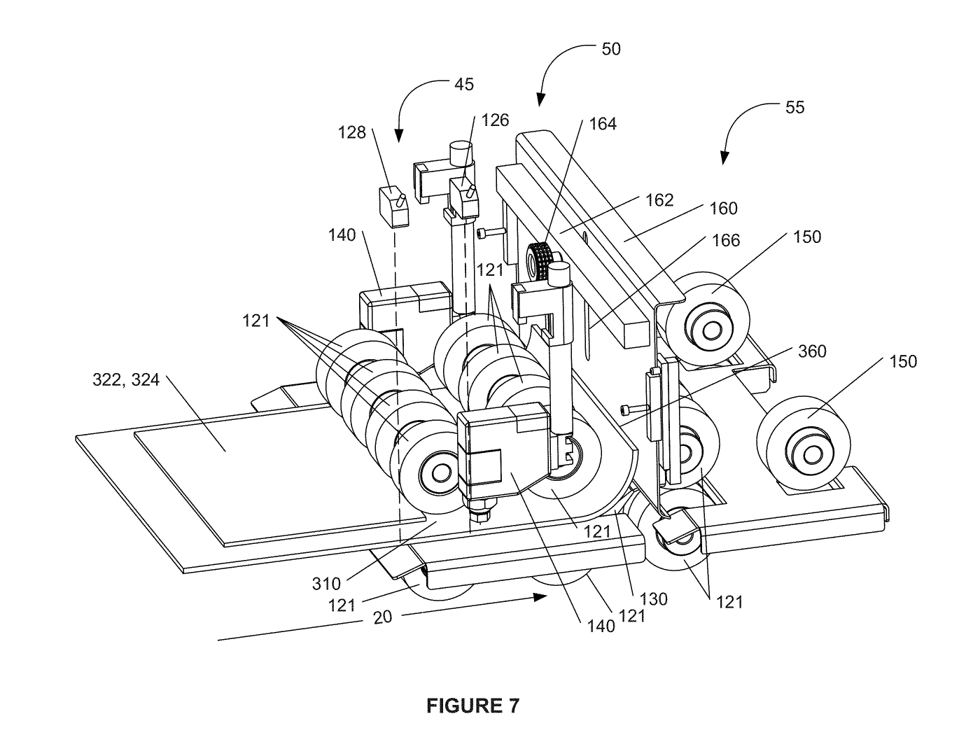

Referring now to FIG. 7, envelope sheet 310 is in a position where fold diverter 130 is triggered by diverter optical sensor 126 sensing leading edge 360 of envelope sheet 310. When triggered, fold diverter 130 is actuated from a first position that is substantially parallel to and/or in line with envelope transport plate 110 into a second, actuated position, in which fold diverter 130 is positioned relative to envelope transport plate 110, such that leading edge 360 contacts fold plate 160 and moves vertically upwards towards fold plate stop bar 162. Envelope sheet 310 is driven vertically up fold plate 160 at the constant speed at which envelope sheet 310 is propelled by transport rollers 121. The transport speed at which envelope sheet 310 is moved by transport rollers 121 is used, such that an actuation time for fold diverter 130 is set, fold diverter 130 returning to the first position after the actuation time elapses. In some embodiments, an optical sensor is used to detect envelope sheet moving vertically up fold plate 160 in order to move fold diverter 130 back to the first position; in some embodiments, this optical sensor can be used to disable adhesive applicators 140 when the lead edge of envelope sheet 310 is not detected. A vertical position of fold plate stop bar 162 is selected based on the dimensions of envelope sheet and the size of the mailpiece to be created. The position of fold plate stop bar 162 is set by fold plate stop bar adjuster 164, which can include a knurled knob threadably engaged on a rod captively passing through a fold plate stop bar slot 166. In some embodiments, detents can be formed in fold plate stop bar slot 166 in order to define preset vertical positions of fold plate stop bar 162, these preset vertical positions corresponding to preset sizes of envelope sheets 310 to be processed.

Referring now to FIG. 8, envelope sheet 310 and insert stack 320 are both shown being engaged (e.g., compressively) between transport rollers 121 as envelope sheet 310 and insert stack 320 are driven by transport rollers at constant velocity. In this view, fold diverter 130 has returned to the first, unactuated, position, such that, after leading edge 360 of envelope sheet 310 contacts fold plate stop bar 162, preventing any further vertical movement along this vertical buckle path, envelope sheet 310 is driven underneath fold plate 160. Because the vertical movement of envelope sheet 310 is stopped by fold plate stop bar 162, but envelope sheet 310 is still being driven at constant velocity by transport rollers 121, envelope sheet 310 is folded over itself at envelope primary fold point 366, defining back region 352 above this point. As is shown in FIG. 8, first and second sets of transport rollers 121A and 121B continue to drive envelope sheet underneath fold plate 160, thus driving envelope primary fold point 366 to be engaged between third set of transport rollers 121C. The speed of envelope sheet 310 and insert sheet 320 are substantially unchanged as envelope primary fold point 366 is defined and insert region of the envelope (see, e.g., 354, FIG. 6) is substantially coplanar with the inserts within insert stack 320.

In FIG. 9, the dispensing of the adhesive, which was omitted in FIG. 8 for clarity, is shown. After first adhesive optical sensor 128 is triggered by leading edge 360 of envelope sheet 310, adhesive is applied by adhesive applicators 140 adjacent to and/or substantially at the lateral edges of envelope sheet 310. The adhesive is, in some embodiments, a pressure-sensitive liquid dispensed glue. In some other embodiments, the adhesive may be dispensed as a gel or as a film, rather than a liquid. Adhesive is applied to envelope sheet 310 at adhesive application point 146, starting at adhesive start point 142 along adhesive line 144. A delay time value may be programmed in order for envelope sheet 310 to move beyond the detection point at which leading edge 360 is detected by first adhesive optical sensor 128, such that the adhesive is not applied prematurely. The duration of adhesive application is set by a timer value based, for example, on the size of envelope sheet 310 and the speed at which transport rollers 121 are operated.

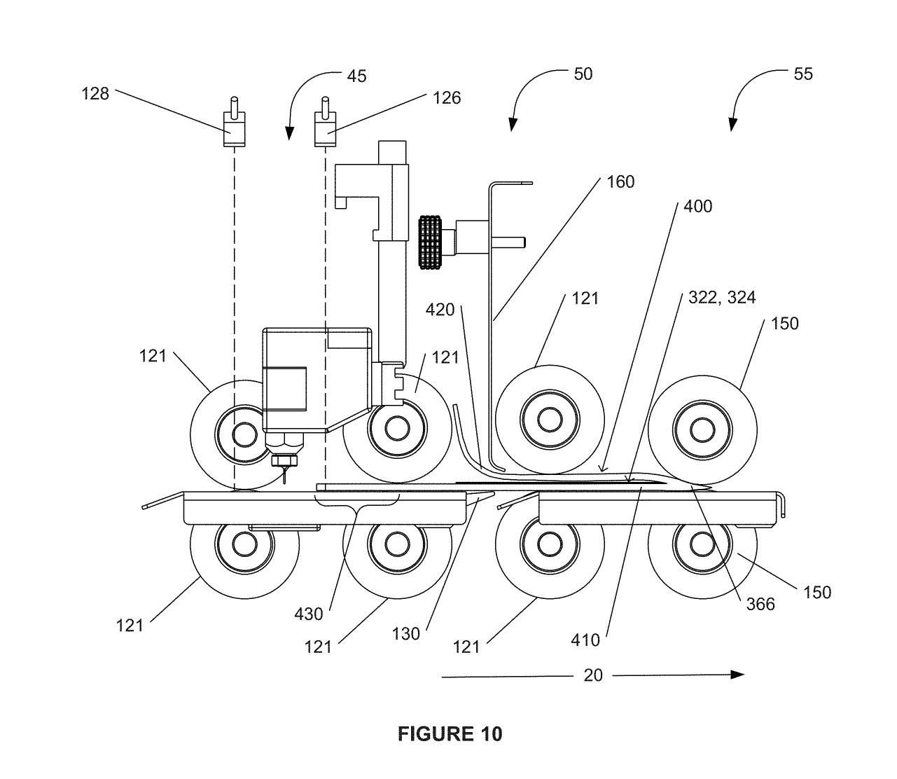

Referring now to FIG. 10, envelope sheet enters side adhesive sealer, generally designated 55. In side adhesive sealer, portions of envelope sheet are sealed to each other, such that a partially assembled envelope, generally designated 400, is formed by pressure sealing of back of envelope 420 to front of envelope 410 between adhesive sealing rollers 150. In some embodiments the adhesive can be applied in a pattern comprising a solid line, dots, and/or dashes, the latter of which can be beneficial in minimizing adhesive consumption. In this view, envelope 400 is pushed along by transport rollers 121 into adhesive sealing rollers 150. In some embodiments, adhesive sealing rollers 150 may be driven at the same speed as transport rollers 121. In some other embodiments, adhesive sealing rollers 150 are configured as idler rollers. In some other embodiments, adhesive sealing rollers 150 and transport rollers 121 are made of an elastomeric material, such as silicone, rubber, or latex. In some other embodiments, adhesive sealing rollers 150 are made from a material having a higher or lower durometer than transport rollers 121, thus providing for an enhanced seal formed by the adhesive. In some embodiments, adhesive sealing rollers 150 and the axles associated therewith are separate from (e.g., physically isolated from) the axles of transport rollers 121, so that the thickness of insert stack 320 does not affect the pressure applied by adhesive sealing rollers 150. This can be accomplished, for example, by adhesive sealing rollers 150 being arranged laterally outside of the width of the widest insert within insert stack 320, such that transport rollers 121 will be vertically displaced by the thickness of insert stack 320 as it moves therethrough, without any accompanying vertical displacement of adhesive sealing rollers 150 associated therewith. In some embodiments, adhesive sealing rollers 150 are arranged laterally outside of transport rollers 121, so that only envelope sheet 310 and the adhesive are compressed between adhesive sealing rollers 150, so that a constant pressure is applied to seal the adhesive, independent of a thickness of insert stack 320.

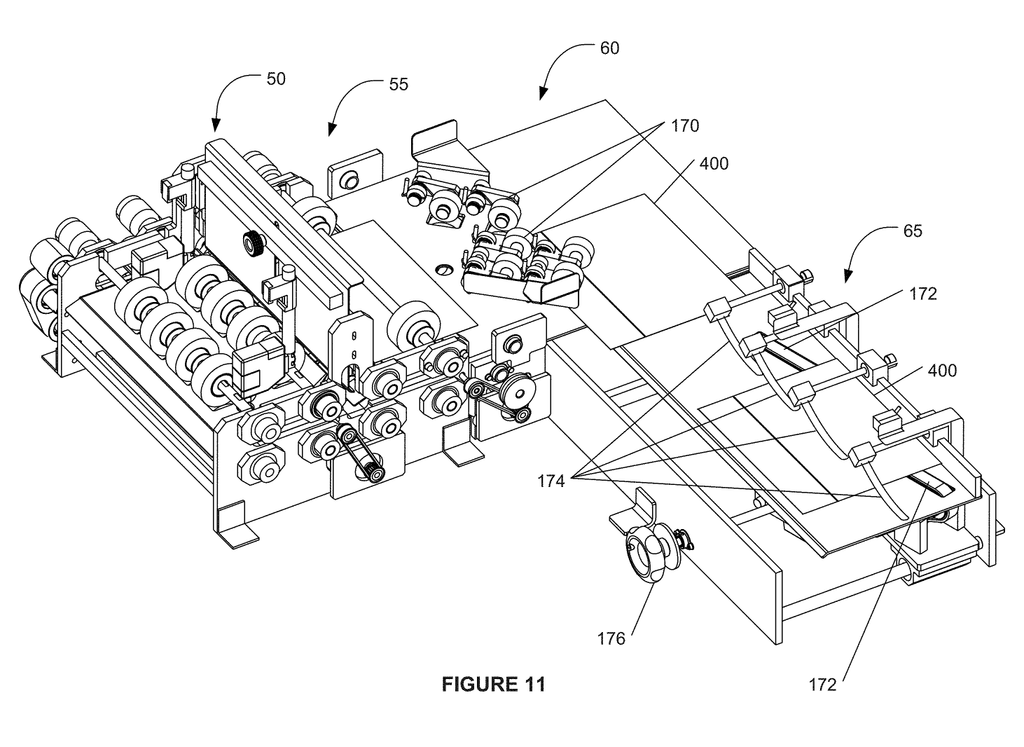

Next, as is shown in FIG. 11, partially assembled envelope 400 exits side adhesive sealer 55, continuing into right angle turn (RAT) module, generally designated 60. RAT module 60 includes one or more (e.g., two) right angle turn assemblies 170, which include a plurality of rollers that alter a directional path of envelope 400 by such that, after envelope 400 moves underneath right angle turn assemblies 170, the direction of travel 20 of envelope 400 is substantially orthogonal compared to the direction of travel 20 before envelope 400 entered the right angle turn assemblies 170. Any suitable RAT module 60 may be used, including those that will physically rotate envelope 400 without altering a travel direction thereof. Next, envelope 400 is bottom edge registered by one or more bottom edge justifier assemblies 172 and the movement of envelope 400 is aided by one or more envelope guides 174. An envelope side adjuster 176 can be used to adjust a behavior of the bottom edge justifier assemblies 172 and/or a position of one or more of the envelope guides 174.

In FIG. 12, envelope 400 is transferred into flap creaser region 70, where movement of envelope is controlled by a plurality of spring-loaded rollers 183 that are aligned vertically over plow fold guide 184. In the embodiment shown, plow fold guide is one or more driven belts that move underneath envelope 400. In some embodiments, rollers 183 are not spring-loaded, but are held in place by gravity. In some other embodiments, one or more of rollers 183 is driven to apply a locomotive force to envelopes 400. Envelope 400 has a crease formed therein at a location above which envelope flap 430 (see, e.g., FIG. 10) is to be formed. Envelope 400 is driven and/or pulled in between grooved crease roller 180 and peaked crease roller 181 to for the crease. Crease rollers 180 and 181 can be driven or idler rollers. After the crease is formed, envelope 400 enters flap adhesive applicator region 75, which can be immediately adjacent to crease rollers 180 and 181. In flap adhesive applicator region, an optical photo sensor 185 is triggered and flap adhesive applicator dispenses an adhesive onto envelope flap 430 above the crease line defining envelope flap 430. The adhesive dispensed can be either the same or a different adhesive as was shown and described relative to FIG. 8. After the adhesive is applied, envelope 400 enters flap plow folder region 85 and engages within and/or around plow folder 186. Next, envelope flap 430 is pressed and sealed against envelope front 410 by flap sealer 188 in flap sealer region 85. After being sealed (e.g., compressively between rollers), envelope 400 is deposited into output region 90 for transport and delivery by a designated postal service carrier.

Accordingly, while methods, systems, and devices have been described herein regarding specific embodiments, features, and illustrative embodiments, it will be appreciated that the utility of the subject matter is not thus limited, but rather extends to and encompasses numerous other variations, modifications and alternative embodiments, as will suggest themselves to those of ordinary skill in the field of the present subject matter, based on the disclosure herein.

Various combinations and sub-combinations of the structures and features described herein are contemplated and will be apparent to a skilled person having knowledge of this disclosure. Any of the various features and elements as disclosed herein may be combined with one or more other disclosed features and elements unless indicated to the contrary herein. Correspondingly, the subject matter as hereinafter claimed is intended to be broadly construed and interpreted, as including all such variations, modifications and alternative embodiments, within its scope and including equivalents of the claims.

It is understood that various details of the presently disclosed subject matter may be changed without departing from the scope of the presently disclosed subject matter. Furthermore, the foregoing description is for the purpose of illustration only, and not for the purpose of limitation.

### REFERENCE NUMBER LIST

1—Primary Transport Path
2—Insert Transport Path
10—Mailpiece Inveloping System
20—Direction of Travel
21—Insert Direction of Travel
25—Envelope Sheet Feeder
30—Insert Feeder
35—Insert Stager
40—Merge Region
45—Adhesive Applicator Region
50—Buckle Folder System
55—Side Adhesive Sealer
60—Right Angle Turn Module
65—Bottom Edge Justifier
70—Flap Creaser
75—Flap Adhesive Applicator
80—Flap Plow Folder
85—Flap Sealer
90—Output Section
95—Envelope Closing System
96—Server
98—User Terminal
100—Computer
102—Envelope Sheet Hopper
104—Envelope Sheet Dispenser
106—Feeder Rollers
110—Envelope Transport Plate
111—Envelope Conveyor
112—Envelope Conveyor Belt Tabs
113—Envelope Conveyor Belt
114—Envelope Edge Justifier
117—Paper Dispenser and Cutter
120—Transport Roller Drive Motor
121—Transport Rollers
122—Roller Drive Belt
124—Drive Belt Travel Direction
126—Diverter Optical Sensor
128—First Adhesive Optical Sensor
130—Fold Diverter
132—Fold Diverter Motor
140—Adhesive Applicator
142—Adhesive Start Point
144—Adhesive Line
146—Adhesive Application Point
148—Waste Adhesive Reservoir
150—Adhesive Sealing Roller
160—Fold Plate
162—Fold Plate Stop Bar
164—Fold Plate Stop Bar Adjuster
166—Fold Plate Stop Bar Slot
170—Right Angle Turn Assemblies
172—Bottom Edge Justifier Assembly
174—Envelope Guide
176—Envelope Size Adjuster
180—Crease Roller—Groove
181—Crease Roller—Peak
182—Flap Adhesive Applicator
183—Spring-Loaded Roller(s)
184—Plow Fold Guide
185—Optical Photo Sensor
186—Plow Folder
188—Flap Sealer
200—Insert Feeder
201—Crank Arm
202—Coupler Linkage
203—Coupler Bearing
204—Insert Idler Roller
205—Insert Drive Roller
206—Idler Rocker Arm
207—Idler Pivot
208—Motor
209—Motor Direction
210—Insert Transport Plate
211—Insert Idler Roller Support Spring
212—Insert Idler Roller Pivot Arm
213—Insert Idler Linkage Arm
214—Coupler Linkage Travel Path
215—Stop Gate Rocker Arm
216—Pivot Bearing
217—Stop Gate Rocker Arm Travel Path
218—Idler Rocker Arm Travel Path
219—Insert Idler Roller Travel Path
220—Stop Gate Pivot Bearing
221—Insert Idler Pivot Bearing
222—Rocker Arm Drive Rod
225—Stop gate connection bar
230—Insert Assembly Transport Belt
232—Insert Assembly Belt Tabs
233—Stager Transport Plate
234—Stager Transport Belt
235—Insert Guide Plate
240—Holding Slot
242—Insert Side Jogger Rollers
250—Merge Drive Roller
252—Merge Idler Roller
259—Stop Gate Optical Sensor
260—Stop Gate
262—Stop Gate Travel Path
264—Merge Optical Sensor
280—Mechanical Linkage System
282—First Linkage Subassembly
284—Second Linkage Subassembly
310—Envelope Sheet
312—Envelope Window
314—Dispensing Position (FIG. 5)
320—Insert Stack
322—Primary Insert
324—Secondary Insert
350—Flap Region
352—Back Region
354—Insert Region (FIG. 6)
360—Leading Edge of Envelope
366—Envelope Primary Fold Point
400—Assembled Envelope
410—Front of Envelope
420—Back of Envelope
430—Flap of Envelope

What is claimed is:

1. A system configured to fold an envelope sheet around one or more insert sheets to create a mailpiece, the system comprising:
an insert transport path configured to transport the one or more insert sheets to a merge region;
a primary transport path configured to transport the envelope sheet to the merge region;
an insert stager that is connected to the insert transport path and arranged proximate to the primary transport path at the merge region, wherein the insert stager is configured to receive the one or more insert sheets from the insert transport path in a form of an insert stack, hold the insert stack until the envelope sheet is detected at a first position on the primary transport path, and to dispense the insert stack onto the envelope sheet as the envelope sheet is being transported along the primary transport path, wherein the insert stack is dispensed from the insert stager at substantially a same speed as a speed at which the envelope sheet moves along the primary transport path;
an adhesive dispensing system configured to seal sides of the envelope by applying glue along lateral edges of a back side portion of the envelope sheet as the envelope sheet is fed into a buckle folder;
a buckle folder system configured to form an unsealed envelope for the mailpiece by folding the envelope sheet around the insert stack, wherein folding the envelope sheet around the insert stack forms, on a first side of the insert stack, a back side of the mailpiece and, on a second side of the insert stack opposite the first side, a flap and a front of the mailpiece; and
an envelope closing system configured to close and seal the unsealed envelope by folding the flap over the back side and adhesively sealing the flap to the back side of the mailpiece.

2. The system of claim 1, wherein the insert stager comprises a stop gate to hold the insert stack until the envelope sheet is detected at the first position on the primary transport path, and a mechanical linkage system configured to receive a single input to generate first and second motion profiles, which are separate and distinct from each other, wherein the first motion profile defines a movement of the stop gate, wherein the second motion profile defines a movement of the insert idler roller, and wherein a motor is rotationally coupled to the mechanical linkage system by a crank arm, such that the crank arm transmits a single rotary motion of the motor to generate the first and second motion profiles.

3. The system of claim 1, wherein a first insert feeder of the one or more insert feeders is configured to deposit a first insert sheet of the one or more insert sheets as a bottom insert sheet of the insert stack, wherein subsequent insert sheets of the one or more insert sheets are deposited from subsequent insert feeders of the one or more insert feeders over the first insert sheet, wherein the first insert sheet has at least one dimension that is larger or a same size as each of the subsequent insert sheets of the insert stack, and wherein each respective insert sheet of the subsequent insert sheets is a same size and/or smaller than the first insert sheet and each of the subsequent insert sheets underneath the respective insert sheet in the insert stack.

4. The system of claim 1, wherein the primary transport path is configured to receive the envelope sheet from an envelope sheet feeder, which is configured to dispense the envelope sheet onto an envelope transport plate of the primary transport path, or from at least one continuous web of paper, which is cut to a size corresponding to a size of the mailpiece and a size of the insert stack.

5. The system of claim 1, wherein the speed at which the envelope sheet moves along the primary transport path is different from a speed at which the one or more insert sheets move along the insert transport path.

6. The system of claim 1, wherein the envelope sheet is continuously in motion while the insert stack is dispensed thereon.

7. The system of claim 1, comprising one or more adhesive applicators configured to apply an adhesive proximate to lateral edges of the envelope sheet over a portion thereof corresponding to, and on an opposite side of the envelope sheet from, the front of the mailpiece.

8. The system of claim 7, comprising:
a fold diverter, which moves between and including a rest position, in which a top surface of the fold diverter is substantially in a same plane as a transport surface of the primary transport path, and an actuated position, in which the fold diverter is oriented such that the top surface thereof is not coplanar with the transport surface of the primary transport path; and
a diverter optical sensor configured to detect a leading edge of the envelope sheet,
wherein the fold diverter moves from the rest position to the actuated position when the leading edge of the envelope sheet is detected,
wherein, when the fold diverter is in the actuated position, the fold diverter is angled to direct the leading edge of the envelope sheet onto a fold plate of the buckle folder system, and
wherein the fold diverter is configured to return to the rest position after a first time period has elapsed.

9. The system of claim 8, wherein, when the leading edge of the envelope sheet is not detected within a second time period, the fold diverter is positioned in the rest position and no adhesive is applied to the envelope sheet by the one or more adhesive applicators.

10. The system of claim 7, wherein the buckle folder system comprises:
a fold plate arranged out of a plane defined by a direction of travel of the envelope sheet along the primary transport path;
a fold diverter configured to divert a leading edge of the envelope sheet onto the fold plate when triggered from a rest position into an actuated position at a same time as or after a diverter optical sensor detects the leading edge of the envelope sheet;
a fold plate stop bar configured to prevent the leading edge of the envelope sheet from moving beyond a position on the fold plate, the position corresponding to a size of the envelope sheet, the insert stack, and/or the mailpiece;
a first plurality of transport rollers that are configured to drive the envelope sheet onto the fold plate until the leading edge of the envelope sheet contacts the fold plate stop bar, and, after the leading edge of the envelope sheet contacts the fold plate stop bar, underneath the fold plate;
a second plurality of transport rollers located behind the fold plate which are configured to fold the envelope sheet at an envelope primary fold point; and
one or more adhesive sealing rollers that are substantially aligned with the lateral edges of the envelope sheet, wherein the one or more adhesive sealing rollers are configured to apply a compressive force to seal the back of the mailpiece onto the front of the mailpiece, forming the unsealed envelope,
wherein the fold diverter is configured to move back to the rest position before or at a same time as the leading edge of the envelope sheet contacts the fold plate stop bar.

11. The system of claim 1, wherein:
each of the one or more insert sheets moving along the insert transport path is rear edge registered,
the envelope sheet moving along the primary transport path is rear edge registered, and
each of the one or more insert sheets are front edge registered within the insert stager.

12. The system of claim 1, wherein the insert stack remains substantially flat while the envelope sheet is folded around the insert stack at the buckle folder system.

13. A method of folding an envelope sheet around one or more insert sheets to create a mailpiece, the method comprising:
forming an insert stack from the one or more insert sheets;
transporting the insert stack to a merge region along an insert transport path;
transporting the envelope sheet to the merge region along a primary transport path;
receiving the insert stack at an insert stager that is connected to the insert transport path and arranged proximate to the primary transport;
holding the insert stack within the insert stager;
detecting the envelope sheet at a first position on the primary path;
dispensing the insert stack onto the envelope sheet as the envelope sheet is transported along the primary transport path, wherein the insert stack is dispensed at substantially a same speed as a speed at which the envelope sheet moves along the primary transport path;
folding the envelope sheet around the insert stack to form an unsealed envelope for the mailpiece, wherein the unsealed envelope comprises, on a first side of the insert stack, a back side of the mailpiece and, on a second side of the insert stack opposite the first side, a flap and a front of the mailpiece; and
closing and sealing the unsealed envelope by folding the flap over the back side and adhesively sealing the flap to the back side of the mailpiece.

14. The method of claim 13, wherein the insert stager comprises a stop gate that holds the insert stack until the envelope sheet is detected at the first position on the primary transport path, and a mechanical linkage system that receives a single input to generate first and second motion profiles, which are separate and distinct from each other, wherein the first motion profile defines a movement of the stop gate, wherein the second motion profile defines a movement of the insert idler roller, and wherein a motor is rotationally coupled to the mechanical linkage system by a crank arm, such that the crank arm transmits a single rotary motion of the motor to generate the first and second motion profiles.

15. The method of claim 13, wherein a first insert feeder of the one or more insert feeders deposits a first insert sheet of the one or more insert sheets as a bottom insert sheet of the insert stack, wherein subsequent insert sheets of the one or more insert sheets are deposited from subsequent insert feeders of the one or more insert feeders over the first insert sheet, wherein the first insert sheet has at least one dimension that is larger or a same size as each of the subsequent insert sheets of the insert stack, and wherein each respective insert sheet of the subsequent insert sheets is a same size and/or smaller than the first insert sheet and each of the subsequent insert sheets underneath the respective insert sheet in the insert stack.

16. The method of claim 13, wherein the primary transport path receives the envelope sheet from an envelope sheet feeder, which dispenses the envelope sheet onto an envelope transport plate of the primary transport path, or from at least one continuous web of paper, which is cut to a size corresponding to a size of the mailpiece and a size of the insert stack.

17. The method of claim 13, wherein the speed at which the envelope sheet moves along the primary transport path is different from a speed at which the one or more insert sheets move along the insert transport path.

18. The method of claim 13, wherein the envelope sheet is continuously in motion while the insert stack is dispensed thereon.

19. The method of claim 13, comprising applying, using one or more adhesive applicators, an adhesive proximate to lateral edges of the envelope sheet over a portion thereof corresponding to, and on an opposite side of the envelope sheet from, the front of the mailpiece.

20. The method of claim 19, comprising:
moving a fold diverter between and including a rest position, in which a top surface of the fold diverter is substantially in a same plane as a transport surface of the primary transport path, and an actuated position, in which the fold diverter is oriented such that the top surface thereof is not coplanar with the transport surface of the primary transport path; and
detecting, using a diverter optical sensor, a leading edge of the envelope sheet,
wherein the fold diverter moves from the rest position to the actuated position when the leading edge of the envelope sheet is detected,
wherein, when the fold diverter is in the actuated position, the fold diverter is angled to direct the leading edge of the envelope sheet onto a fold plate of the buckle folder system, and
wherein the fold diverter returns to the rest position after a first time period has elapsed.

21. The method of claim 20, comprising, when the leading edge of the envelope sheet is not detected within a second time period, moving the fold diverter to the rest position and applying no adhesive to the envelope sheet by any of the one or more adhesive applicators.

22. The method of claim 19, wherein the buckle folder system comprises:
a fold plate arranged out of a plane defined by a direction of travel of the envelope sheet along the primary transport path;
a fold diverter that diverts a leading edge of the envelope sheet onto the fold plate when triggered from a rest position into an actuated position at a same time as or after a diverter optical sensor detects the leading edge of the envelope sheet;
a fold plate stop bar that prevents the leading edge of the envelope sheet from moving beyond a position on the fold plate, the position corresponding to a size of the envelope sheet, the insert stack, and/or the mailpiece;
a first plurality of transport rollers that drive the envelope sheet onto the fold plate until the leading edge of the envelope sheet contacts the fold plate stop bar, and, after the leading edge of the envelope sheet contacts the fold plate stop bar, underneath the fold plate;
a second plurality of transport rollers located behind the fold plate which fold the envelope sheet at an envelope primary fold point; and
one or more adhesive sealing rollers that are substantially aligned with the lateral edges of the envelope sheet, wherein the one or more adhesive sealing rollers apply a compressive force to seal the back of the mailpiece onto the front of the mailpiece, forming the unsealed envelope,
wherein the fold diverter moves back to the rest position before or at a same time as the leading edge of the envelope sheet contacts the fold plate stop bar.

23. The method of claim 13, wherein:
each of the one or more insert sheets moving along the insert transport path is rear edge registered,
the envelope sheet moving along the primary transport path is rear edge registered, and
each of the one or more insert sheets are front edge registered within the insert stager.

24. The method of claim 13, wherein the insert stack remains substantially flat while the envelope sheet is folded around the insert stack at the buckle folder system.

25. A device configured to sequentially receive and dispense one or more insert sheets as an insert stack onto an adjacent envelope sheet, the device comprising:
a holding slot for the insert stack;
a stop gate disposed at an exit of the holding slot; and
a mechanical linkage system configured to produce first and second motion profiles from a single input, the mechanical linkage system comprising:
a motor configured to generate a locomotive force, wherein the locomotive force is the single input;
a crank arm that is connected to the motor;
a coupler linkage coupled, at a first end, to the crank arm via a coupler bearing and, at a second end, to a pivot bearing;
a first linkage subassembly rotatably connected, at a first end, to the coupler linkage at the pivot bearing and comprising a stop gate arranged at a distal end of the first linkage subassembly, the single input being transmitted to the first linkage subassembly through the pivot bearing to generate the first motion profile, wherein the first motion profile is a rotary movement of the stop gate along a stop gate travel path;
one or more insert drive rollers arranged so that one or more portions thereof protrude, at least partially, through a bottom side of the holding slot;
one or more insert idler rollers arranged substantially vertically over the one or more insert drive rollers;
a second linkage subassembly rotatably connected, at a first end, to the coupler linkage at the pivot bearing and comprising the one or more insert idler rollers, the single input being transmitted to the second linkage subassembly through the pivot bearing to generate the second motion profile, wherein the second motion profile is a substantially vertical movement of the one or more insert idler rollers about an idler pivot;
wherein the mechanical linkage system is configured such that the single input simultaneously causes the first and second motion profiles of the stop gate and the one or more insert idler rollers, respectively, and
wherein the first and second motion profiles are different from each other.

26. The device of claim 25, wherein the stop gate comprises a plurality of stop gate portions, and wherein at least one lateral side edge of each of the plurality of stop gate portions comprises a radiused portion.

27. The device of claim 25, wherein the second linkage subassembly comprises:
an idler rocker arm, a first end of which is rotatably connected to the coupler linkage at the pivot bearing and a second end of which is rotatably connected to an insert idler pivot bearing;
an insert idler linkage arm, a first end of which is rotatably connected to the insert idler pivot bearing and a second end of which is rotatably connected to the idler pivot, wherein the one or more insert idler rollers are rotatably attached to the insert idler linkage arm; and
an insert idler roller support spring, which is in contact with the insert idler linkage arm and is configured to apply a rotary force to the insert idler linkage arm relative to the idler pivot,
wherein the one or more insert idler rollers and the one or more insert drive rollers are respectively arranged on opposite sides of the holding slot.

28. The device of claim 27, wherein the insert idler pivot bearing is configured to allow a rotation of the idler rocker arm relative to the insert idler linkage arm when the one or more insert idler rollers are engaged against the one or more insert drive rollers to dispense the insert stack.

29. The device of claim 25, wherein the first linkage subassembly further comprises:
one or more stop gate rocker arms; and
one or more stop gate connection bars,
wherein a first end of each of the one or more stop gate rocker arms is rotatably connected to the coupler linkage at the pivot bearing,
wherein a second end of each of the one or more stop gate rocker arms is rotatably connected to a first end of a respective one of the one or more stop gate connection bars at a stop gate pivot bearing,
wherein the stop gate pivot bearing has a fixed position, such that the first linkage subassembly does not cause a translator motion of the stop gate pivot bearing, and
wherein each of the one or more stop gate connection bars is rigidly connected to a portion of the stop gate.

30. The device of claim 29, wherein a motion of the one or more stop gate rocker arms around the stop gate pivot bearing generates a substantially similar motion of the one or more stop gate connection bars around the stop gate pivot bearing, wherein the motion of the one or more stop gate connection bars drives the stop gate to produce the first motion profile the stop gate transit path, and wherein the stop gate transit path is in a shape of an arc.

31. The device of claim 25, wherein the first motion profile comprises a movement of the stop gate between and including respective first and second positions thereof,
wherein, when the stop gate is in the first position, the exit of the holding slot is obstructed by the stop gate,
wherein, when the stop gate is in the second position, the exit of the holding slot is not obstructed by the stop gate,
wherein the second motion profile comprises a movement of the one or more insert idler rollers between and including respective first and second positions,
wherein, when the one or more insert idler rollers are in the first position, the one or more insert idler rollers are spaced apart from the one or more insert drive rollers,
wherein, when the one or more insert idler rollers are in the second position, the one or more insert idler rollers are positioned relative to the one or more insert drive rollers to apply a compressive force to an insert stack within the holding slot,
wherein the one or more insert drive rollers are rotatably driven and are configured to impart a dispensing force to the insert stack when the one or more insert idler rollers are in the second position to apply a compressive force to the insert stack between the one or more insert idler rollers and the one or more insert drive rollers,
wherein the device is configured to receive a dispensing signal to dispense the insert stack from the device, and
wherein the dispensing signal triggers the single input from the motor.

32. The device of claim 31, comprising a stop gate optical sensor configured to detect an insert stack within the holding slot, wherein the one or more insert idler rollers and the stop gate are triggered to move towards the respective second positions when an insert stack is detected by the stop gate optical sensor and the dispensing signal is received by the device to dispense the insert stack.
